(19) United States
(12) Patent Application Publication
(10) Pub. No.: US 2016/0363077 A1
(43) Pub. Date: Dec. 15, 2016

(54) FUEL SYSTEM ABNORMALITY DETECTING DEVICE OF INTERNAL COMBUSTION ENGINE

(71) Applicant: Toyota Jidosha Kabushiki Kaisha, Toyota-shi Aichi-ken (JP)

(72) Inventors: Yusuke Suzuki, Hadano-shi Kanagawa-ken (JP); Hiroshi Sawada, Gotenba-shi Shizuoka-ken (JP)

(21) Appl. No.: 15/140,171

(22) Filed: Apr. 27, 2016

(30) Foreign Application Priority Data
Jun. 11, 2015 (JP) 2015-118249

(51) Int. Cl. F02D 41/22; F02D 41/40; F02D 41/14

(52) U.S. Cl. CPC F02D 41/22; F02D 41/1443; F02D 41/1448; F02D 41/401; F02D 2041/224

(57) ABSTRACT

An abnormality detecting device of an internal combustion engine, has a heat generation amount calculating portion for calculating a heat generation amount on the basis of an in-cylinder pressure detected by an in-cylinder pressure sensor, a combustion mass percentage calculating portion for calculating a combustion mass percentage on the basis of the heat generation amount, a fuel injection amount calculating portion for calculating a fuel injection amount on the basis of a crank angle period from ignition timing of a spark plug to when the combustion mass percentage reaches a first value, an ignition timing calculating portion for calculating the ignition timing on the basis of a crank angle when the combustion mass percentage reaches a second value, and an abnormality cause discriminating portion for discriminating a cause of abnormality on the basis of the fuel injection amount, the in-cylinder pressure, and the heat generation amount.

### TECHNICAL FIELD

The present disclosure relates to an abnormality detecting device of an internal combustion engine having an in-cylinder pressure sensor.

### BACKGROUND

An internal combustion engine having an in-cylinder pressure sensor is known. The internal combustion engine is described in Japanese Patent Application Publication No. 2014-125942 (JP-A-2014-125942). In the internal combustion engine described in JP-A-2014-125942, a malfunction mode of abnormality occurring to the in-cylinder pressure sensor is specified.

The internal combustion engine described in JP-A-2014-125942 can specify a cause of a malfunction of the in-cylinder pressure sensor. However, the internal combustion engine described in JP-A-2014-125942 cannot discriminate a cause of abnormality of the internal combustion engine. Namely, the internal combustion engine described in JP-A-2014-125942 can discriminate a cause of abnormality of the in-cylinder pressure sensor. However, when abnormality of the internal combustion engine described in JP-A-2014-125942 occurs, the internal combustion engine described in JP-A-2014-125942 cannot discriminate a part which has abnormality from a plurality of another parts which constitute the internal combustion engine.

### SUMMARY

An object of the present disclosure is to provide an abnormality detecting device of an internal combustion engine which can discriminate a cause of abnormality of the internal combustion engine.

Through diligent research, the inventors of the present disclosure have discovered that when the abnormality occurs in the internal combustion engine, the cause of the abnormality can be discriminated by analyzing a fuel injection amount, an in-cylinder pressure, and a heat generation amount, wherein in the internal combustion engine, the in-cylinder pressure is detected by an in-cylinder pressure sensor, the heat generation amount is calculated on the basis of the in-cylinder pressure, a combustion mass percentage is calculated on the basis of the heat generation amount, fuel injection amount control (SA-CA10 control, which is explained in detail below) is executed on the basis of a crank angle period from ignition timing to when the combustion mass percentage reaches a predetermined value, and ignition timing control (MBT control, which is explained in detail below) is executed on the basis of a crank angle when the combustion mass percentage reaches another predetermined value.

Namely, through the diligent research, the inventors of the present disclosure have discovered that when the abnormality occurs in the internal combustion engine, a part having the abnormality can be discriminated from a plurality of another parts which constitute the internal combustion engine.

Considering the above, the present disclosure provides an abnormality detecting device of an internal combustion engine, comprising:

a cylinder;

an in-cylinder pressure sensor for detecting an in-cylinder pressure, the in-cylinder pressure being a combustion pressure in the cylinder;

a spark plug placed in the cylinder;

a fuel injection valve;

a crank angle sensor;

a heat generation amount calculating portion for calculating a heat generation amount on the basis of the in-cylinder pressure detected by the in-cylinder pressure sensor;

a combustion mass percentage calculating portion for calculating a combustion mass percentage on the basis of the heat generation amount calculated by the heat generation amount calculating portion;

a crank angle period calculating portion for calculating a crank angle period from ignition timing of the spark plug to when the combustion mass percentage reaches a first value on the basis of crank angles detected by the crank angle sensor;

a fuel injection amount calculating portion for calculating a fuel injection amount injected from the fuel injection valve on the basis of the crank angle period calculated by the crank angle period calculating portion;

a crank angle calculating portion for calculating a crank angle when the combustion mass percentage reaches a second value;

an ignition timing calculating portion for calculating the ignition timing on the basis of the crank angle calculated by the crank angle calculating portion; and

an abnormality cause discriminating portion for discriminating a cause of abnormality on the basis of the fuel injection amount calculated by the fuel injection amount calculating portion, the in-cylinder pressure detected by the in-cylinder pressure sensor, and the heat generation amount calculated by the heat generation amount calculating portion.

Namely, in the abnormality detecting device of the internal combustion engine of the present disclosure, the cause of the abnormality of the internal combustion engine can be discriminated, wherein the cause of the abnormality of the internal combustion engine cannot be discriminated in the internal combustion engine described in JP-A-2014-125942.

Particularly, through the diligent research, the inventors of the present disclosure have discovered that when sensitivity of the in-cylinder pressure sensor does not decrease, and when the abnormality relating to combustion deterioration in the cylinder occurs, an increase of the fuel injection amount calculated by the fuel injection amount calculating portion is larger than a fuel injection amount increase threshold, the in-cylinder pressure detected by the in-cylinder pressure sensor does not change, and the heat generation amount calculated by the heat generation amount calculating portion increases.

Through the diligent research, the inventors of the present disclosure have discovered that when the sensitivity of the in-cylinder pressure sensor does not decrease, and when the abnormality relating to increment of the crank angle period calculated by the crank angle period calculating portion occurs, the increase of the fuel injection amount calculated by the fuel injection amount calculating portion is larger than the fuel injection amount increase threshold, the in-cylinder pressure detected by the in-cylinder pressure sensor does not change, and the heat generation amount calculated by the heat generation amount calculating portion increases, wherein the abnormality relating to the increment of the crank angle period is caused by an induction noise.

Through the diligent research, the inventors of the present disclosure have discovered that when the sensitivity of the in-cylinder pressure sensor does not decrease, and when the abnormality relating to decrement of the crank angle period calculated by the crank angle period calculating portion occurs, a decrease of the fuel injection amount calculated by the fuel injection amount calculating portion is larger than a fuel injection amount decrease threshold, the in-cylinder pressure detected by the in-cylinder pressure sensor does not change, and the heat generation amount calculated by the heat generation amount calculating portion decreases, wherein the abnormality relating to the decrement of the crank angle period is caused by the induction noise.

Considering the above, in the abnormality detecting device of the internal combustion engine of the present disclosure, if the increase of the fuel injection amount calculated by the fuel injection amount calculating portion is larger than the fuel injection amount increase threshold, if the in-cylinder pressure detected by the in-cylinder pressure sensor is smaller than or equal to an in-cylinder pressure increase threshold, if the in-cylinder pressure detected by the in-cylinder pressure sensor is larger than an in-cylinder pressure decrease threshold, and if the heat generation amount calculated by the heat generation amount calculating portion is larger than a heat generation amount increase threshold, the abnormality cause discriminating portion may judge that there is a possibility that at least one of the abnormality relating to the combustion deterioration in the cylinder, and the abnormality relating to the increment of the crank angle period calculated by the crank angle period calculating portion occurs, wherein the abnormality relating to the increment of the crank angle period is caused by the induction noise. Also, in the abnormality detecting device of the internal combustion engine of the present disclosure, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is smaller than or equal to a heat generation amount decrease threshold, the abnormality cause discriminating portion may judge that there is a possibility that the abnormality relating to the decrement of the crank angle period calculated by the crank angle period calculating portion occurs, wherein the abnormality relating to the decrement of the crank angle period is caused by the induction noise.

Namely, in the abnormality detecting device of the internal combustion engine of the present disclosure, the abnormality relating to the combustion deterioration in the cylinder, the abnormality relating to the increment of the crank angle period calculated by the crank angle period calculating portion, and the abnormality relating to the decrement of the crank angle period calculated by the crank angle period calculating portion, can be discriminated from another abnormality, wherein the abnormality relating to the increment of the crank angle period is caused by the induction noise, and the abnormality relating to the decrement of the crank angle period is caused by the induction noise. Particularly, if a plurality of cylinders are provided, one cylinder in which the abnormality occurs can be discriminated from another cylinders.

Also, through the diligent research, the inventors of the present disclosure have discovered that when the sensitivity of the in-cylinder pressure sensor does not decrease, and when the abnormality relating to decrement of a flow rate of fuel injected from the fuel injection valve occurs, the increase of the fuel injection amount calculated by the fuel injection amount calculating portion is larger than the fuel injection amount increase threshold, the in-cylinder pressure detected by the in-cylinder pressure sensor does not change, and a decrease of the heat generation amount calculated by the heat generation amount calculating portion is larger than or equal to zero.

Through the diligent research, the inventors of the present disclosure have discovered that when the sensitivity of the in-cylinder pressure sensor does not decrease, and when the abnormality relating to increment of the flow rate of the fuel injected from the fuel injection valve occurs, the decrease of the fuel injection amount calculated by the fuel injection amount calculating portion is larger than the fuel injection amount decrease threshold, the in-cylinder pressure detected by the in-cylinder pressure sensor does not change, and an increase of the heat generation amount calculated by the heat generation amount calculating portion is larger than or equal to zero.

Considering the above, in the abnormality detecting device of the internal combustion engine of the present disclosure, if the increase of the fuel injection amount calculated by the fuel injection amount calculating portion is larger than the fuel injection amount increase threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is smaller than or equal to the heat generation amount increase threshold, the abnormality cause discriminating portion may judge that the abnormality relating to the decrement of the flow rate of the fuel injected from the fuel injection valve occurs. Also, in the abnormality detecting device of the internal combustion engine of the present disclosure, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is larger than the heat generation amount decrease threshold, the abnormality cause discriminating portion may judge that the abnormality relating to increment of the flow rate of the fuel injected from the fuel injection valve occurs.

Namely, in the abnormality detecting device of the internal combustion engine of the present disclosure, the abnormality relating to the decrement of the flow rate of the fuel injected from the fuel injection valve, and the abnormality relating to the increment of the flow rate of the fuel injected from the fuel injection valve, can be discriminated from another abnormality. Particularly, if the plurality of the cylinders are provided, one cylinder in which the abnormality occurs can be discriminated from another cylinders.

Also, through the diligent research, the inventors of the present disclosure have discovered that when the sensitivity of the in-cylinder pressure sensor does not decrease, and when the abnormality relating to a quantity of air supplied to one cylinder of the plurality of the cylinders being larger than the quantity of the air supplied to another cylinder of the plurality of the cylinders, occurs, in said one cylinder of the plurality of the cylinders, the increase of the fuel injection amount calculated by the fuel injection amount calculating portion is larger than the fuel injection amount increase threshold, the in-cylinder pressure detected by the in-cylinder pressure sensor increases, and the heat generation amount calculated by the heat generation amount calculating portion increases.

Through the diligent research, the inventors of the present disclosure have discovered that when the sensitivity of the in-cylinder pressure sensor does not decrease, and when the abnormality relating to the quantity of the air supplied to one cylinder of the plurality of the cylinders being smaller than the quantity of the air supplied to another cylinder of the plurality of the cylinders, occurs, in said one cylinder of the plurality of the cylinders, the decrease of the fuel injection amount calculated by the fuel injection amount calculating portion is larger than the fuel injection amount decrease threshold, the in-cylinder pressure detected by the in-cylinder pressure sensor decreases, and the heat generation amount calculated by the heat generation amount calculating portion decreases.

Considering the above, the abnormality detecting device of the internal combustion engine of the present disclosure may further comprise the plurality of the cylinders. In the abnormality detecting device of the internal combustion engine of the present disclosure, in one cylinder of the plurality of the cylinders, if the increase of the fuel injection amount calculated by the fuel injection amount calculating portion is larger than the fuel injection amount increase threshold, if the in-cylinder pressure detected by the in-cylinder pressure sensor is larger than the in-cylinder pressure increase threshold, and if the heat generation amount calculated by the heat generation amount calculating portion is larger than the heat generation amount increase threshold, the abnormality cause discriminating portion may judge that the abnormality relating to the quantity of the air supplied to said one cylinder of the plurality of the cylinders being larger than the quantity of the air supplied to another cylinder of the plurality of the cylinders, occurs. Also, in the abnormality detecting device of the internal combustion engine of the present disclosure, in said one cylinder of the plurality of the cylinders, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure decrease threshold, and if the heat generation amount calculated by the heat generation amount calculating portion is smaller than or equal to the heat generation amount decrease threshold, the abnormality cause discriminating portion may judge that the abnormality relating to the quantity of the air supplied to said one cylinder of the plurality of the cylinders being smaller than the quantity of the air supplied to said another cylinder of the plurality of the cylinders, occurs.

Namely, in the abnormality detecting device of the internal combustion engine of the present disclosure, the abnormality relating to the quantity of the air supplied to said one cylinder of the plurality of the cylinders being larger than the quantity of the air supplied to another cylinder of the plurality of the cylinders, and the abnormality relating to the quantity of the air supplied to said one cylinder of the plurality of the cylinders being smaller than the quantity of the air supplied to said another cylinder of the plurality of the cylinders, can be discriminated from another abnormality.

Also, through the diligent research, the inventors of the present disclosure have discovered that when the sensitivity of the in-cylinder pressure sensor does not decrease, and when the abnormality relating to decrement of an air flow rate measured by an air flow meter occurs, in all of the plurality of the cylinders, the increase of the fuel injection amount calculated by the fuel injection amount calculating portion is larger than the fuel injection amount increase threshold, the in-cylinder pressure detected by the in-cylinder pressure sensor increases, and the heat generation amount calculated by the heat generation amount calculating portion increases.

Through the diligent research, the inventors of the present disclosure have discovered that when the sensitivity of the in-cylinder pressure sensor does not decrease, and when the abnormality relating to increment of the air flow rate measured by the air flow meter occurs, in all of the plurality of the cylinders, the decrease of the fuel injection amount calculated by the fuel injection amount calculating portion is larger than the fuel injection amount decrease threshold, the in-cylinder pressure detected by the in-cylinder pressure sensor decreases, and the heat generation amount calculated by the heat generation amount calculating portion decreases.

Considering the above, the abnormality detecting device of the internal combustion engine of the present disclosure may further comprise the plurality of the cylinders; divergent air intake passages, each of the divergent air intake passages extending from each of the plurality of the cylinders; a confluence air intake passage formed by merging the divergent air intake passages; and the air flow meter placed in the confluence air intake passage. In the abnormality detecting device of the internal combustion engine of the present disclosure, in all of the plurality of the cylinders, if the increase of the fuel injection amount calculated by the fuel injection amount calculating portion is larger than the fuel injection amount increase threshold, if the in-cylinder pressure detected by the in-cylinder pressure sensor is larger than the in-cylinder pressure increase threshold, and if the heat generation amount calculated by the heat generation amount calculating portion is larger than the heat generation amount increase threshold, the abnormality cause discriminating portion may judge that the abnormality relating to the decrement of the air flow rate measured by the air flow meter occurs. Also, in the abnormality detecting device of the internal combustion engine of the present disclosure, in said all of the plurality of the cylinders, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure decrease threshold, and if the heat generation amount calculated by the heat generation amount calculating portion is smaller than or equal to the heat generation amount decrease threshold, the abnormality cause discriminating portion may judge that the abnormality relating to the increment of the air flow rate measured by the air flow meter occurs.

Namely, in the abnormality detecting device of the internal combustion engine of the present disclosure, the abnormality relating to the decrement of the air flow rate measured by the air flow meter, and the abnormality relating to the increment of the air flow rate measured by the air flow meter, can be discriminated from another abnormality.

Also, through the diligent research, the inventors of the present disclosure have discovered that when the sensitivity of the in-cylinder pressure sensor does not decrease, and when the abnormality relating to decrement of a flow rate of fuel flowing through a confluence fuel supply system (e.g. the abnormality relating to the decrement of the flow rate of a fuel pump) occurs, in all of the plurality of the cylinders, the increase of the fuel injection amount calculated by the fuel injection amount calculating portion is larger than the fuel injection amount increase threshold, the in-cylinder pressure detected by the in-cylinder pressure sensor does not change, and the decrease of the heat generation amount calculated by the heat generation amount calculating portion is larger than or equal to zero.

Through the diligent research, the inventors of the present disclosure have discovered that when the sensitivity of the in-cylinder pressure sensor does not decrease, and when the abnormality relating to increment of the flow rate of the fuel flowing through the confluence fuel supply system (e.g. the abnormality relating to the increment of the flow rate of the fuel pump) occurs, in all of the plurality of the cylinders, the decrease of the fuel injection amount calculated by the fuel injection amount calculating portion is larger than the fuel injection amount decrease threshold, the in-cylinder pressure detected by the in-cylinder pressure sensor does not change, and the increase of the heat generation amount calculated by the heat generation amount calculating portion is larger than or equal to zero.

Considering the above, the abnormality detecting device of the internal combustion engine of the present disclosure may further comprise the plurality of the cylinders; a plurality of fuel injection valves; divergent fuel supply systems, each of the divergent fuel supply systems extending from each of the plurality of the fuel injection valves; and the confluence fuel supply system formed by merging the divergent fuel supply systems. In the abnormality detecting device of the internal combustion engine of the present disclosure, in all of the plurality of the cylinders, if the increase of the fuel injection amount calculated by the fuel injection amount calculating portion is larger than the fuel injection amount increase threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is smaller than or equal to the heat generation amount increase threshold, the abnormality cause discriminating portion may judge that the abnormality relating to the decrement of the flow rate of the fuel flowing through the confluence fuel supply system occurs. Also, in the abnormality detecting device of the internal combustion engine of the present disclosure, in said all of the plurality of the cylinders, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is larger than the heat generation amount decrease threshold, the abnormality cause discriminating portion may judge that the abnormality relating to the increment of the flow rate of the fuel flowing through the confluence fuel supply system occurs.

Namely, in the abnormality detecting device of the internal combustion engine of the present disclosure, the abnormality relating to the decrement of the flow rate of the fuel flowing through the confluence fuel supply system, and the abnormality relating to the increment of the flow rate of the fuel flowing through the confluence fuel supply system, can be discriminated from another abnormality.

Also, through the diligent research, the inventors of the present disclosure have discovered that a ratio of the heat generation amount to the in-cylinder pressure when the sensitivity of the in-cylinder pressure sensor does not decrease, is not different from the ratio of the heat generation amount to the in-cylinder pressure when the sensitivity of the in-cylinder pressure sensor decreases, wherein decrement of the sensitivity of the in-cylinder pressure sensor is caused by a secular change, etc.

Through the diligent research, the inventors of the present disclosure have discovered that even when the sensitivity of the in-cylinder pressure sensor decreases because of the secular change, etc., the cause of the abnormality of the internal combustion engine can be discriminated on the basis of the ratio of the heat generation amount to the in-cylinder pressure.

Considering the above, in the abnormality detecting device of the internal combustion engine of the present disclosure, the abnormality cause discriminating portion may discriminate the cause of the abnormality on the basis of the fuel injection amount, the in-cylinder pressure, the heat generation amount, and the ratio of the heat generation amount to the in-cylinder pressure.

Namely, in the abnormality detecting device of the internal combustion engine of the present disclosure, the cause of the abnormality of the internal combustion engine can be discriminated, even when the sensitivity of the in-cylinder pressure sensor decreases because of the secular change, etc.

Also, through the diligent research, the inventors of the present disclosure have discovered that when sensitivity of the in-cylinder pressure sensor does not decrease, and when the abnormality relating to the combustion deterioration in the cylinder occurs, the increase of the fuel injection amount calculated by the fuel injection amount calculating portion is larger than the fuel injection amount increase threshold, the in-cylinder pressure detected by the in-cylinder pressure sensor does not change, the heat generation amount calculated by the heat generation amount calculating portion increases in comparison with a change of the in-cylinder pressure, and the ratio of the heat generation amount to the in-cylinder pressure increases.

Through the diligent research, the inventors of the present disclosure have discovered that when sensitivity of the in-cylinder pressure sensor decreases, and when the abnormality relating to the combustion deterioration in the cylinder occurs, the increase of the fuel injection amount calculated by the fuel injection amount calculating portion is larger than the fuel injection amount increase threshold, the in-cylinder pressure detected by the in-cylinder pressure sensor decreases, the heat generation amount calculated by the heat generation amount calculating portion increases in comparison with the change of the in-cylinder pressure, and the ratio of the heat generation amount to the in-cylinder pressure increases.

Through the diligent research, the inventors of the present disclosure have discovered that when the sensitivity of the in-cylinder pressure sensor does not decrease, and when the abnormality relating to the increment of the crank angle period calculated by the crank angle period calculating portion occurs, the increase of the fuel injection amount calculated by the fuel injection amount calculating portion is larger than the fuel injection amount increase threshold, the in-cylinder pressure detected by the in-cylinder pressure sensor does not change, the heat generation amount calculated by the heat generation amount calculating portion increases in comparison with the change of the in-cylinder pressure, and the ratio of the heat generation amount to the in-cylinder pressure increases, wherein the abnormality relating to the increment of the crank angle period is caused by the induction noise.

Through the diligent research, the inventors of the present disclosure have discovered that when the sensitivity of the in-cylinder pressure sensor decreases, and when the abnormality relating to the increment of the crank angle period calculated by the crank angle period calculating portion occurs, the increase of the fuel injection amount calculated by the fuel injection amount calculating portion is larger than the fuel injection amount increase threshold, the in-cylinder pressure detected by the in-cylinder pressure sensor decreases, the heat generation amount calculated by the heat generation amount calculating portion increases in comparison with the change of the in-cylinder pressure, and the ratio of the heat generation amount to the in-cylinder pressure increases, wherein the abnormality relating to the increment of the crank angle period is caused by the induction noise.

Through the diligent research, the inventors of the present disclosure have discovered that when the sensitivity of the in-cylinder pressure sensor does not decrease, and when the abnormality relating to the decrement of the crank angle period calculated by the crank angle period calculating portion occurs, the decrease of the fuel injection amount calculated by the fuel injection amount calculating portion is larger than the fuel injection amount decrease threshold, the in-cylinder pressure detected by the in-cylinder pressure sensor does not change, the heat generation amount calculated by the heat generation amount calculating portion decreases in comparison with the change of the in-cylinder pressure, and the ratio of the heat generation amount to the in-cylinder pressure decreases, wherein the abnormality relating to the decrement of the crank angle period is caused by the induction noise.

Through the diligent research, the inventors of the present disclosure have discovered that when the sensitivity of the in-cylinder pressure sensor decreases, and when the abnormality relating to the decrement of the crank angle period calculated by the crank angle period calculating portion occurs, the decrease of the fuel injection amount calculated by the fuel injection amount calculating portion is larger than the fuel injection amount decrease threshold, the in-cylinder pressure detected by the in-cylinder pressure sensor decreases, the heat generation amount calculated by the heat generation amount calculating portion decreases in comparison with the change of the in-cylinder pressure, and the ratio of the heat generation amount to the in-cylinder pressure decreases, wherein the abnormality relating to the decrement of the crank angle period is caused by the induction noise.

Considering the above, in the abnormality detecting device of the internal combustion engine of the present disclosure, if the increase of the fuel injection amount calculated by the fuel injection amount calculating portion is larger than the fuel injection amount increase threshold, if the in-cylinder pressure detected by the in-cylinder pressure sensor is smaller than or equal to the in-cylinder pressure increase threshold, if the heat generation amount calculated by the heat generation amount calculating portion increases in comparison with the change of the in-cylinder pressure, and if the ratio of the heat generation amount to the in-cylinder pressure is larger than a ratio increase threshold, the abnormality cause discriminating portion may judge that there is a possibility that at least one of the abnormality relating to the combustion deterioration in the cylinder, and the abnormality relating to the increment of the crank angle period calculated by the crank angle period calculating portion occurs, wherein the abnormality relating to the increment of the crank angle period is caused by the induction noise. Also, in the abnormality detecting device of the internal combustion engine of the present disclosure, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion decreases in comparison with the change of the in-cylinder pressure, and if the ratio of the heat generation amount to the in-cylinder pressure is smaller than or equal to a ratio decrease threshold, the abnormality cause discriminating portion may judge that there is a possibility that the abnormality relating to the decrement of the crank angle period calculated by the crank angle period calculating portion occurs, wherein the abnormality relating to the decrement of the crank angle period is caused by the induction noise.

Namely, in the abnormality detecting device of the internal combustion engine of the present disclosure, even when the sensitivity of the in-cylinder pressure sensor decreases because of the secular change, etc., the abnormality relating to the combustion deterioration in the cylinder, the abnormality relating to the increment of the crank angle period calculated by the crank angle period calculating portion, and the abnormality relating to the decrement of the crank angle period calculated by the crank angle period calculating portion, can be discriminated from another abnormality, wherein the abnormality relating to the increment of the crank angle period, and the abnormality relating to the decrement of the crank angle period, are caused by the induction noise.

Also, through the diligent research, the inventors of the present disclosure have discovered that when the sensitivity of the in-cylinder pressure sensor does not decrease, and when the abnormality relating to the decrement of the flow rate of the fuel injected from the fuel injection valve occurs, the increase of the fuel injection amount calculated by the fuel injection amount calculating portion is larger than the fuel injection amount increase threshold, the in-cylinder pressure detected by the in-cylinder pressure sensor does not change, the decrease of the heat generation amount calculated by the heat generation amount calculating portion is larger than or equal to zero, the heat generation amount calculated by the heat generation amount calculating portion decreases in comparison with the change of the in-cylinder pressure, and a decrease of the ratio of the heat generation amount to the in-cylinder pressure is larger than or equal to zero.

Through the diligent research, the inventors of the present disclosure have discovered that when the sensitivity of the in-cylinder pressure sensor decreases, and when the abnormality relating to the decrement of the flow rate of the fuel injected from the fuel injection valve occurs, the increase of the fuel injection amount calculated by the fuel injection amount calculating portion is larger than the fuel injection amount increase threshold, the in-cylinder pressure detected by the in-cylinder pressure sensor decreases, the decrease of the heat generation amount calculated by the heat generation amount calculating portion is larger than or equal to zero, the heat generation amount calculated by the heat generation amount calculating portion decreases in comparison with the change of the in-cylinder pressure, and the decrease of the ratio of the heat generation amount to the in-cylinder pressure is larger than or equal to zero.

Through the diligent research, the inventors of the present disclosure have discovered that when the sensitivity of the in-cylinder pressure sensor does not decrease, and when the abnormality relating to the increment of the flow rate of the fuel injected from the fuel injection valve occurs, the decrease of the fuel injection amount calculated by the fuel injection amount calculating portion is larger than the fuel injection amount decrease threshold, the in-cylinder pressure detected by the in-cylinder pressure sensor does not change, the decrease of the heat generation amount calculated by the heat generation amount calculating portion is larger than or equal to zero, the heat generation amount calculated by the heat generation amount calculating portion increases in comparison with the change of the in-cylinder pressure, and an increase of the ratio of the heat generation amount to the in-cylinder pressure is larger than or equal to zero.

Through the diligent research, the inventors of the present disclosure have discovered that when the sensitivity of the in-cylinder pressure sensor decreases, and when the abnormality relating to the increment of the flow rate of the fuel injected from the fuel injection valve occurs, the decrease of the fuel injection amount calculated by the fuel injection amount calculating portion is larger than the fuel injection amount decrease threshold, the in-cylinder pressure detected by the in-cylinder pressure sensor decreases, the decrease of the heat generation amount calculated by the heat generation amount calculating portion is larger than or equal to zero, the heat generation amount calculated by the heat generation amount calculating portion increases in comparison with the change of the in-cylinder pressure, and the increase of the ratio of the heat generation amount to the in-cylinder pressure is larger than or equal to zero.

Considering the above, in the abnormality detecting device of the internal combustion engine of the present disclosure, if the increase of the fuel injection amount calculated by the fuel injection amount calculating portion is larger than the fuel injection amount increase threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion decreases in comparison with the change of the in-cylinder pressure, and if the ratio of the heat generation amount to the in-cylinder pressure is smaller than or equal to the ratio increase threshold, the abnormality cause discriminating portion may judge that the abnormality relating to the decrement of the flow rate of the fuel injected from the fuel injection valve occurs. Also, in the abnormality detecting device of the internal combustion engine of the present disclosure, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion increases in comparison with the change of the in-cylinder pressure, and if the ratio of the heat generation amount to the in-cylinder pressure is larger than the ratio decrease threshold, the abnormality cause discriminating portion may judge that the abnormality relating to the increment of the flow rate of the fuel injected from the fuel injection valve occurs.

Namely, in the abnormality detecting device of the internal combustion engine of the present disclosure, even when the sensitivity of the in-cylinder pressure sensor decreases because of the secular change, etc., the abnormality relating to the decrement of the flow rate of the fuel injected from the fuel injection valve, and the abnormality relating to the increment of the flow rate of the fuel injected from the fuel injection valve, can be discriminated from another abnormality. Particularly, if the plurality of the cylinders are provided, one cylinder in which the abnormality occurs can be discriminated from another cylinders.

Also, through the diligent research, the inventors of the present disclosure have discovered that when the sensitivity of the in-cylinder pressure sensor does not decrease, and when the abnormality relating to the decrement of the flow rate of the fuel flowing through the confluence fuel supply system (e.g. the abnormality relating to the decrement of the flow rate of the fuel pump) occurs, in all of the plurality of the cylinders, the increase of the fuel injection amount calculated by the fuel injection amount calculating portion is larger than the fuel injection amount increase threshold, the in-cylinder pressure detected by the in-cylinder pressure sensor does not change, the decrease of the heat generation amount calculated by the heat generation amount calculating portion is larger than or equal to zero, the heat generation amount calculated by the heat generation amount calculating portion decreases in comparison with the change of the in-cylinder pressure, and the decrease of the ratio of the heat generation amount to the in-cylinder pressure is larger than or equal to zero.

Through the diligent research, the inventors of the present disclosure have discovered that when the sensitivity of the in-cylinder pressure sensor decreases, and when the abnormality relating to the decrement of the flow rate of the fuel flowing through the confluence fuel supply system (e.g. the abnormality relating to the decrement of the flow rate of the fuel pump) occurs, in all of the plurality of the cylinders, the increase of the fuel injection amount calculated by the fuel injection amount calculating portion is larger than the fuel injection amount increase threshold, the in-cylinder pressure detected by the in-cylinder pressure sensor decreases, the decrease of the heat generation amount calculated by the heat generation amount calculating portion is larger than or equal to zero, the heat generation amount calculated by the heat generation amount calculating portion decreases in comparison with the change of the in-cylinder pressure, and the decrease of the ratio of the heat generation amount to the in-cylinder pressure is larger than or equal to zero.

Through the diligent research, the inventors of the present disclosure have discovered that when the sensitivity of the in-cylinder pressure sensor does not decrease, and when the abnormality relating to the increment of the flow rate of the fuel flowing through the confluence fuel supply system (e.g. the abnormality relating to the increment of the flow rate of the fuel pump) occurs, in all of the plurality of the cylinders, the decrease of the fuel injection amount calculated by the fuel injection amount calculating portion is larger than the fuel injection amount decrease threshold, the in-cylinder pressure detected by the in-cylinder pressure sensor does not change, the decrease of the heat generation amount calculated by the heat generation amount calculating portion is larger than or equal to zero, the heat generation amount calculated by the heat generation amount calculating portion increases in comparison with the change of the in-cylinder pressure, and the increase of the ratio of the heat generation amount to the in-cylinder pressure is larger than or equal to zero.

Through the diligent research, the inventors of the present disclosure have discovered that when the sensitivity of the in-cylinder pressure sensor decreases, and when the abnormality relating to the increment of the flow rate of the fuel flowing through the confluence fuel supply system (e.g. the abnormality relating to the increment of the flow rate of the fuel pump) occurs, in all of the plurality of the cylinders, the decrease of the fuel injection amount calculated by the fuel injection amount calculating portion is larger than the fuel injection amount decrease threshold, the in-cylinder pressure detected by the in-cylinder pressure sensor decreases, the decrease of the heat generation amount calculated by the heat generation amount calculating portion is larger than or equal to zero, the heat generation amount calculated by the heat generation amount calculating portion increases in comparison with the change of the in-cylinder pressure, and the increase of the ratio of the heat generation amount to the in-cylinder pressure is larger than or equal to zero.

Considering the above, the abnormality detecting device of the internal combustion engine of the present disclosure may further comprise the plurality of the cylinders; the plurality of the fuel injection valves; the divergent fuel supply systems, each of the divergent fuel supply systems extending from each of the plurality of the fuel injection valves; and the confluence fuel supply system formed by merging the divergent fuel supply systems. In the abnormality detecting device of the internal combustion engine of the present disclosure, in all of the plurality of the cylinders, if the increase of the fuel injection amount calculated by the fuel injection amount calculating portion is larger than the fuel injection amount increase threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion decreases in comparison with the change of the in-cylinder pressure, and if the ratio of the heat generation amount to the in-cylinder pressure is smaller than or equal to the ratio increase threshold, the abnormality cause discriminating portion may judge that the abnormality relating to the decrement of the flow rate of the fuel flowing through the confluence fuel supply system occurs. Also, in the abnormality detecting device of the internal combustion engine of the present disclosure, in said all of the plurality of the cylinders, if the decrease of the fuel injection amount calculated by the fuel injection amount calculating portion is larger than the fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion increases in comparison with the change of the in-cylinder pressure, and if the ratio of the heat generation amount to the in-cylinder pressure is larger than the ratio decrease threshold, the abnormality cause discriminating portion may judge that the abnormality relating to the increment of the flow rate of the fuel flowing through the confluence fuel supply system occurs.

Namely, in the abnormality detecting device of the internal combustion engine of the present disclosure, even when the sensitivity of the in-cylinder pressure sensor decreases because of the secular change, etc., the abnormality relating to the decrement of the flow rate of the fuel flowing through the confluence fuel supply system, and the abnormality relating to the increment of the flow rate of the fuel flowing through the confluence fuel supply system, can be discriminated from another abnormality.

Other and further objects, features and advantages of the present disclosure will appear more fully from the following description.

### BRIEF DESCRIPTION OF THE DRAWINGS

FIG. 1 is a schematic view of an engine system, to which a first embodiment of an abnormality detecting device of an internal combustion engine of the present disclosure is applied.

FIG. 2 is a detail view of an electric control unit (ECU) 40 in FIG. 1.

FIG. 3 is a flowchart which explains a routine executed in the first embodiment of the abnormality detecting device of the internal combustion engine.

FIG. 4 is a flowchart which explains another routine executed in the first embodiment of the abnormality detecting device of the internal combustion engine.

FIG. 5 is a flowchart which explains a routine executed in a second embodiment of the abnormality detecting device of the internal combustion engine.

FIG. 6 is a table which explains a result of diligent research by the inventors of the present disclosure, when sensitivity of an in-cylinder pressure sensor 30 does not decrease.

FIG. 7 is another table which explains a result of diligent research by the inventors of the present disclosure, when sensitivity of an in-cylinder pressure sensor 30 does not decrease.

FIG. 8 is a table which explains a result of the diligent research by the inventors of the present disclosure, when the sensitivity of the in-cylinder pressure sensor 30 does not decrease and when the sensitivity of the in-cylinder pressure sensor 30 decreases.

FIG. 9 is another table which explains a result of the diligent research by the inventors of the present disclosure, when the sensitivity of the in-cylinder pressure sensor 30 does not decrease and when the sensitivity of the in-cylinder pressure sensor 30 decreases.

### DETAILED DESCRIPTION OF THE PREFERRED EMBODIMENTS

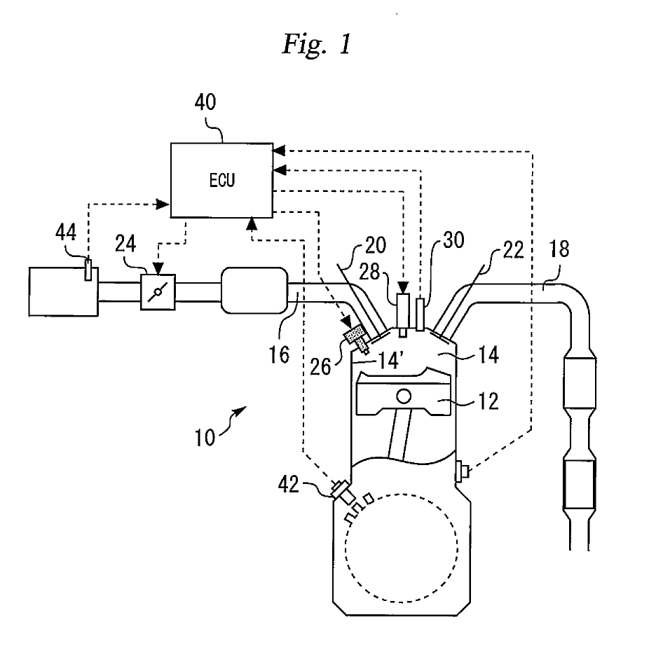

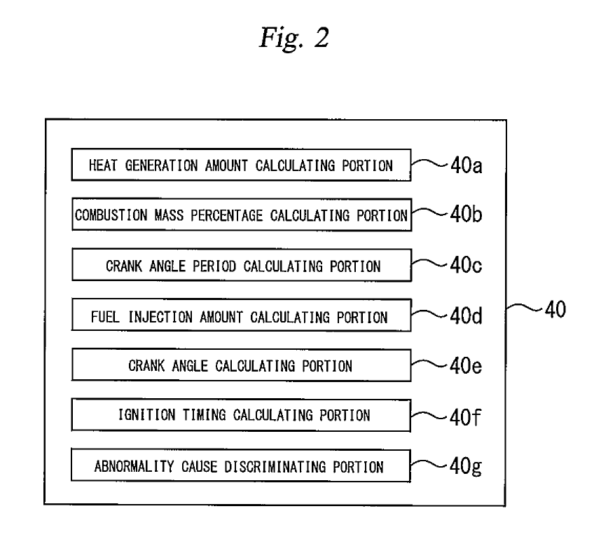

A first embodiment of an abnormality detecting device of an internal combustion engine of the present disclosure is explained below. FIG. 1 is a schematic view of an engine system, to which the first embodiment of the abnormality detecting device of the internal combustion engine of the present disclosure is applied. FIG. 2 is a detail view of an electric control unit (ECU) 40 in FIG. 1.

In the engine system shown in FIG. 1, a spark ignition type internal combustion engine 10 is provided. A piston 12 is placed in a cylinder 14′ of the internal combustion engine 10. The piston 12 separates an inside of the cylinder 14′ into an upper space and a lower space, and the upper space constitutes a combustion chamber 14. The combustion chamber 14 is connected to an air intake passage 16 and an exhaust passage 18.

An air intake port constitutes a part of the air intake passage 16. An intake valve 20 is placed in the air intake port in order to open or close the air intake port. An exhaust port constitutes a part of the exhaust passage 18. An exhaust valve 22 is placed in the exhaust port in order to open or close the exhaust port. An electronically controlled throttle valve 24 is placed in the air intake passage 16.

Although only one cylinder 14′ is shown in FIG. 1, another cylinders (not shown) are provided besides the cylinder 14′ in an example shown in FIG. 1.

In the example shown in FIG. 1, the abnormality detecting device of the internal combustion engine of the present disclosure is applied to the internal combustion engine 10 having a plurality of the cylinders. In another example, the abnormality detecting device of the internal combustion engine of the present disclosure can be applied to an internal combustion engine having only one cylinder.

In the example shown in FIG. 1, a fuel injection valve 26 for directly injecting fuel into the combustion chamber 14 (into the cylinder 14′), and a spark plug 28 for igniting an air-fuel mixture are provided with each cylinder of the internal combustion engine 10. An in-cylinder pressure sensor 30 for detecting an in-cylinder pressure CP is provided with each cylinder, wherein the in-cylinder pressure is a combustion pressure in the cylinder.

In the example shown in FIG. 1, the abnormality detecting device of the internal combustion engine of the present disclosure is applied to the internal combustion engine 10 in which the fuel injection valve 26 directly injects the fuel into the cylinder 14′. In another example, the abnormality detecting device of the internal combustion engine of the present disclosure can be applied to an internal combustion engine in which the fuel injection valve injects the fuel into the air intake port.

The engine system shown in FIG. 1 includes the electric control unit (ECU) 40. Sensors for detecting an operating state of the internal combustion engine 10, e.g. the above-mentioned in-cylinder pressure sensor 30, a crank angle sensor 42 for detecting engine speed, an air flow meter 44 for detecting a quantity of intake air, etc. are connected to an input section in the ECU 40. Actuators for controlling operation of the internal combustion engine 10, e.g. the throttle valve 24, the fuel injection valve 26, the spark plug 28, etc. are connected to an output section in the ECU 40. The ECU 40 drives the actuators on the basis of output of the sensors and a predetermined program, so that engine control, e.g. fuel injection amount control, ignition timing control, etc. is executed. The ECU 40 has a function of converting an analog output signal of the in-cylinder pressure sensor 30 into a digital signal, the digital signal is synchronized with a crank angle. The ECU 40 has a function of acquiring the digital signal. Accordingly, the in-cylinder pressure CP corresponding to arbitrary crank angle timing can be detected within an allowable range of resolution of an A/D convertor in the ECU 40.

In the engine system having the in-cylinder pressure sensor 30 and the crank angle sensor 42 shown in FIG. 1, in-cylinder pressure data (an in-cylinder pressure waveform) can be acquired on a crank angle basis in each cycle of the internal combustion engine 10. Then, an absolute pressure correction is executed with respect to the in-cylinder pressure waveform in a well known manner. A combustion mass percentage MFB can be calculated by using the in-cylinder pressure waveform after the absolute pressure correction.

Concretely, a heat generation amount HR in the cylinder 14′ at an arbitrary crank angle θ can be calculated by using the in-cylinder pressure data, in accordance with e.g. a following formula 1. Then, the combustion mass percentage MFB at the arbitrary crank angle θ can be calculated by using data of the heat generation amount HR in the cylinder 14′, in accordance with e.g. a following formula 2. Consequently, a crank angle CA α when a value of the combustion mass percentage MFB is a predetermined percentage α [%], can be acquired by using the formula 2.

$$\begin{matrix}HR = \int P d V + \frac{1}{κ - 1} ( PV - {P}_{0} {V}_{0} ) & ( formula 1 ) \\ MFB = \frac{HR ( θ ) - HR ( {θ}_{sta} )}{HR ( {θ}_{fin} ) - HR ( {θ}_{sta} )} & ( formula 2 )\end{matrix}$$

In the formula 1, P represents the in-cylinder pressure CP, V represents in-cylinder volume, κ represents a specific heat ratio of in-cylinder gas, P₀ represents the in-cylinder pressure CP at a beginning of calculation θo, and V₀ represents the in-cylinder volume at the beginning of the calculation, wherein the beginning of the calculation θo is a predetermined crank angle θ during a compression stroke after the intake valve 20 is closed, and wherein the predetermined crank angle θ is set with enough margin with respect to an assumed beginning of combustion. In the formula 2, θₛₜₐ represents the beginning of the combustion (CA0), and θ_{fin} represents an end of the combustion (CA100).

Namely, in the engine system, to which the first embodiment of the abnormality detecting device of the internal combustion engine is applied, shown in FIG. 1, the heat generation amount HR is calculated on the basis of the in-cylinder pressure CP detected by the in-cylinder pressure sensor 30, the in-cylinder volume, and e.g. the formula 1, by the heat generation amount calculating portion 40a (see FIG. 2) in the ECU 40. The combustion mass percentage MFB is calculated on the basis of the heat generation amount HR calculated by the heat generation amount calculating portion 40a, and e.g. the formula 2, by the combustion mass percentage calculating portion 40b (see FIG. 2) in the ECU 40.

A representative value of the crank angle CA α is explained below. The air-fuel mixture is ignited in ignition timing SA, and then, the combustion starts with an ignition delay in the cylinder 14′. The beginning of the combustion is designated as the crank angle CA0. Namely, the beginning of increment of the combustion mass percentage MFB is designated as the crank angle CA0. A crank angle period (CA0-CA10) from the crank angle CA0 to when the combustion mass percentage MFB is 10% corresponds to an initial combustion period. The crank angle period (CA10-CA90) from the crank angle CA10 to when the combustion mass percentage MFB is 90% corresponds to a main combustion period. The crank angle CA50 when the combustion mass percentage MFB is 50% corresponds to a position of a combustion center of mass.

A lean burn operation in which an air fuel ratio is larger than a theoretical air fuel ratio, is effective as a fuel economy technology of the internal combustion engine. Fuel efficiency improves, and a NOx emission level decreases, in accordance with increment of the air fuel ratio. If the air fuel ratio becomes lean excessively, combustion deterioration occurs and the fuel efficiency deteriorates. A torque fluctuation increases gradually in accordance with the increment of the air fuel ratio. When the air fuel ratio becomes lean and exceeds a predetermined value, the torque fluctuation increases drastically.

Preferably, in order to actualize a fuel economy and decrease the NOx emission level, a state of the internal combustion engine 10 is observed, and the air fuel ratio is controlled as lean as possible so that drivability does not deteriorate.

In the engine system, to which the first embodiment of the abnormality detecting device of the internal combustion engine is applied, shown in FIG. 1, in each cylinder 14′, the in-cylinder pressure CP is detected by the in-cylinder pressure sensor 30, the heat generation amount HR is calculated by the heat generation amount calculating portion 40a (see FIG. 2) on the basis of the in-cylinder pressure CP and the formula 1, for example. Then, in each cylinder 14′, the combustion mass percentage MFB is calculated by the combustion mass percentage calculating portion 40b (see FIG. 2) on the basis of the heat generation amount HR and the formula 2, for example. Then, in each cylinder 14′, the crank angle period (SA-CA10) from the ignition timing SA to when the combustion mass percentage MFB reaches a predetermined value such as 10% (the crank angle CA10) is calculated by the crank angle period calculating portion 40c (see FIG. 2). Then, in each cylinder 14′, the fuel injection amount is calculated by the fuel injection amount calculating portion 40d (see FIG. 2) on the basis of the crank angle period (SA-CA10). Fuel injection amount feedback control (SA-CA10 control) is executed in each cylinder 14′. Because there is a high correlation between the crank angle period and the air fuel ratio, the air fuel ratio is indirectly controlled by executing the SA-CA10 control.

Namely, in the engine system, to which the first embodiment of the abnormality detecting device of the internal combustion engine is applied, shown in FIG. 1, the fuel injection amount feedback control is not executed on the basis of an output of an air fuel ratio sensor (not shown) placed in a confluence exhaust passage formed by merging divergent exhaust passages, but the fuel injection amount feedback control (SA-CA10 control) is executed in each cylinder 14′ on the basis of the crank angle period (SA-CA10), wherein each of the divergent exhaust passages extends from each of the plurality of the cylinders, the divergent exhaust passages constitute a part of the exhaust passage 18, and the confluence exhaust passage constitutes a part of the exhaust passage 18.

Accordingly, in the engine system, to which the first embodiment of the abnormality detecting device of the internal combustion engine is applied, shown in FIG. 1, the feedback control, in which dispersion among the cylinders is suppressed, can be executed.

In the example shown in FIG. 1, the abnormality detecting device of the internal combustion engine of the present disclosure is applied to the internal combustion engine 10, wherein the fuel injection amount feedback control (SA-CA10 control) is executed in each cylinder 14′ on the basis of the crank angle period from the ignition timing SA to the crank angle CA10 when the combustion mass percentage MFB reaches 10%. In another example, the abnormality detecting device of the internal combustion engine of the present disclosure can be applied to an internal combustion engine, wherein the fuel injection amount feedback control is executed in each cylinder on the basis of the crank angle period from the ignition timing SA to the crank angle when the combustion mass percentage MFB reaches a predetermined value other than 10%.

The ignition timing control in the engine system, to which the first embodiment of the abnormality detecting device of the internal combustion engine is applied, shown in FIG. 1, is explained below. Because combustion speed changes in accordance with a change of the air fuel ratio, the ignition timing corresponding to optimum ignition timing MBT (Minimum advance for the Best Torque) changes in accordance with the air fuel ratio. Concretely, e.g. if the air fuel ratio becomes lean, the combustion speed decrease, accordingly, early ignition is required. Consequently, the optimum ignition timing MBT is advanced.

While the fuel injection amount feedback control is executed, the air fuel ratio fluctuates within a certain range. Accordingly, the optimum ignition timing MBT fluctuates within a certain range. Although the optimum ignition timing MBT is advanced, if the ignition timing is not changed but stable, e.g. during the lean burn operation, there is a possibility that the air fuel ratio increases beyond a limit and a misfire occurs, because of the fuel injection amount feedback control based on the crank angle period (SA-CA10).

Namely, if the fuel injection amount feedback control is executed on the basis of the crank angle period (SA-CA10), and if the lean burn operation is executed, it is preferable that the ignition timing control is executed in each cylinder in order to eliminate an effect of a change of the optimum ignition timing MBT caused by the change of the air fuel ratio, wherein the change of the air fuel ratio occurs when the fuel injection amount feedback control is executed on the basis of the crank angle period (SA-CA10).

Accordingly, in the engine system, to which the first embodiment of the abnormality detecting device of the internal combustion engine is applied, shown in FIG. 1, the fuel injection amount feedback control is executed on the basis of the crank angle period (SA-CA10), and the ignition timing control (MBT control) based on the crank angle CA50 when the combustion mass percentage MFB is 50%, is executed in order to eliminate the effect of the change of the optimum ignition timing MBT.

Particularly, through diligent research, the inventors of the present disclosure have discovered that under a lean burn operation condition, a change of the crank angle CA50 when the optimum ignition timing is obtained, with respect to a change of the air fuel ratio, is approximately zero. Accordingly, if the lean burn operation is executed, the ignition timing control based on the crank angle CA50 (MBT control) is suitable.

Considering the above, in the engine system, to which the first embodiment of the abnormality detecting device of the internal combustion engine is applied, shown in FIG. 1, the ignition timing control based on the crank angle CA50 (MBT control) is executed. Particularly, in order to eliminate the effect of the change of the optimum ignition timing MBT, the crank angle CA50 when the combustion mass percentage MFB reaches 50%, is calculated by a crank angle calculating portion 40e (see FIG. 2) in the ECU 40. Then, the ignition timing based on the crank angle CA50 is calculated by an ignition timing calculating portion 40f (see FIG. 2) in the ECU 40.

Namely, in the engine system, to which the first embodiment of the abnormality detecting device of the internal combustion engine is applied, shown in FIG. 1, while the ignition timing control (MBT control) using the crank angle CA50 is executed, the fuel injection amount feedback control (SA-CA10 control) using the crank angle period (SA-CA10) is executed.

In the example shown in FIG. 1, the abnormality detecting device of the internal combustion engine of the present disclosure is applied to the internal combustion engine 10 in which the ignition timing control (MBT control) based on the crank angle CA50 when the combustion mass percentage MFB reaches 50%, is executed in each cylinder 14′. In another example, the abnormality detecting device of the internal combustion engine of the present disclosure can be applied to an internal combustion engine in which the ignition timing control based on the crank angle when the combustion mass percentage MFB reaches a predetermined value other than 50%, is executed in each cylinder.

In an engine system in which the fuel injection amount feedback control (SA-CA10 control) based on the crank angle period (SA-CA10) is executed, the ignition timing control (MBT control) based on the crank angle CA50 is executed, and the lean burn operation is executed, such as the engine system, to which the first embodiment of the abnormality detecting device of the internal combustion engine is applied, shown in FIG. 1, if an increase of the fuel injection amount calculated by the fuel injection amount calculating portion 40d (see FIG. 2) is larger than a fuel injection amount increase threshold (particularly, if a rate of a change of the fuel injection amount is larger than e.g. 1.4), or if a decrease of the fuel injection amount calculated by the fuel injection amount calculating portion 40d (see FIG. 2) is larger than a fuel injection amount decrease threshold (particularly, if the rate of the change of the fuel injection amount is smaller than e.g. 0.6), it is judged that abnormality detected by an OBD (On Board Diagnosis) occurs.

Particularly, it is judged that the abnormality occurs in a cylinder, in which the increase of the fuel injection amount is larger than the fuel injection amount increase threshold, or the decrease of the fuel injection amount is larger than the fuel injection amount decrease threshold. Concretely, there are a case in which the abnormality occurs in only a part of the plurality of the cylinders, and a case in which the abnormality occurs in all of the plurality of the cylinders.

In a typical engine system, it is possible to judge that the abnormality occurs in the cylinders, but it is not possible to discriminate a cause of the abnormality. Concretely, it is not possible to discriminate between a component which includes the abnormality and a component which does not include the abnormality, of a plurality of components which constitutes the engine system.

In order to discriminate the cause of the abnormality which occurs in the engine system, particularly in order to facilitate measures (e.g. repair) against the abnormality which occurs in the engine system, the inventors of the present disclosure have made the diligent research.

Concretely, through the diligent research, the inventors of the present disclosure have discovered that in the engine system shown in FIG. 1, in which the in-cylinder pressure CP is detected by the in-cylinder pressure sensor 30, the heat generation amount HR is calculated on the basis of the in-cylinder pressure CP, the combustion mass percentage MFB is calculated on the basis of the heat generation amount HR, the fuel injection amount is controlled on the basis of the crank angle period (SA-CA10) from the ignition timing SA to the crank angle CA10 when the combustion mass percentage MFB reaches 10%, and the ignition timing is controlled on the basis of the crank angle CA50 when the combustion mass percentage MFB reaches 50%, the cause of the abnormality in the engine system can be discriminated by analyzing the fuel injection amount, the in-cylinder pressure CP and the heat generation amount HR, when the abnormality occurs.

Namely, through the diligent research, the inventors of the present disclosure have discovered that when the abnormality occurs in the engine system, it is possible to discriminate between the component which includes the abnormality and the component which does not include the abnormality, of the plurality of the components which constitutes the engine system.

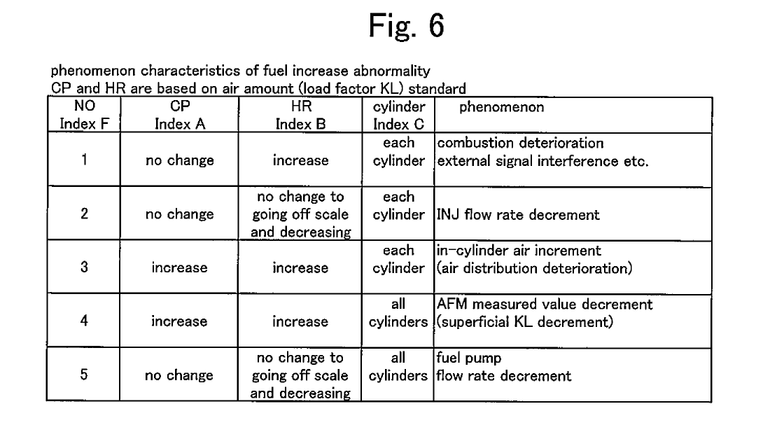

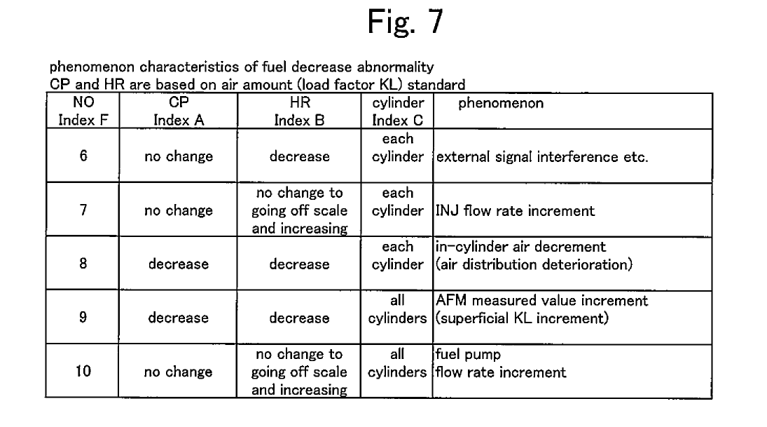

FIGS. 6 and 7 are tables which explain a result of the diligent research by the inventors of the present disclosure, when sensitivity of the in-cylinder pressure sensor 30 does not decrease.

Referring to an Index F=1 in FIG. 6, through the diligent research, the inventors of the present disclosure have discovered that when the sensitivity of the in-cylinder pressure sensor 30 does not decrease, and when the abnormality relating to the combustion deterioration in the cylinder 14′ occurs, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, and the heat generation amount HR (Index B) calculated by the heat generation amount calculating portion 40a (see FIG. 2) increases.

Referring to the Index F=1 in FIG. 6, through the diligent research, the inventors of the present disclosure have discovered that when the sensitivity of the in-cylinder pressure sensor 30 does not decrease, and when the abnormality relating to increment of the crank angle period (SA-CA10) calculated by the crank angle period calculating portion 40c (see FIG. 2) occurs, the increase of the fuel injection amount calculated by the fuel injection amount calculating portion 40d is larger than the fuel injection amount increase threshold, the in-cylinder pressure CP (Index A) detected by the in-cylinder pressure sensor 30 does not change, and the heat generation amount HR (Index B) calculated by the heat generation amount calculating portion 40a increases, wherein the abnormality relating to the increment of the crank angle period (SA-CA10) is caused by an induction noise (external signal interference).

Referring to an Index F=6 in FIG. 7, through the diligent research, the inventors of the present disclosure have discovered that when the sensitivity of the in-cylinder pressure sensor 30 does not decrease, and when the abnormality relating to decrement of the crank angle period (SA-CA10) calculated by the crank angle period calculating portion 40c occurs, the decrease of the fuel injection amount calculated by the fuel injection amount calculating portion 40d is larger than the fuel injection amount decrease threshold, the in-cylinder pressure CP (Index A) detected by the in-cylinder pressure sensor 30 does not change, and the heat generation amount HR (Index B) calculated by the heat generation amount calculating portion 40a decreases, wherein the abnormality relating to the decrement of the crank angle period (SA-CA10) is caused by the induction noise (external signal interference).

Particularly, through the diligent research, the inventors of the present disclosure have discovered that phenomena of the Index F=1 and the Index F=6 occur in each cylinder in which the abnormality occurs (Index C).

It is considered that examples of the combustion deterioration include e.g. the combustion deterioration caused by a secular change of the spark plug 28, and the combustion deterioration caused by failure in formation of the air-fuel mixture. When the combustion deterioration occurs, even if the fuel injection amount is normal, the ignition delay increases. When the ignition delay increases, it is judged that the fuel is short in the SA-CA10 control, and then, the fuel injection amount calculated by the fuel injection amount calculating portion 40d is larger than a normal value.

When the abnormality in which the crank angle period (SA-CA10) calculated by the crank angle period calculating portion 40c increases because of the induction noise (external signal interference) from an outside, occurs, it is judged that the fuel is short, and then, the fuel injection amount calculated by the fuel injection amount calculating portion 40d is larger than the normal value.

Referring to an Index F=2 in FIG. 6, through the diligent research, the inventors of the present disclosure have discovered that when the sensitivity of the in-cylinder pressure sensor 30 does not decrease, and when the abnormality relating to decrement of a flow rate of the fuel injected from the fuel injection valve (INJ) 26 occurs, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, and a decrease of the heat generation amount HR (Index B) calculated by the heat generation amount calculating portion 40a (see FIG. 2) is larger than or equal to zero.

Referring to an Index F=7 in FIG. 7, through the diligent research, the inventors of the present disclosure have discovered that when the sensitivity of the in-cylinder pressure sensor 30 does not decrease, and when the abnormality relating to increment of the flow rate of the fuel injected from the fuel injection valve (INJ) 26 occurs, the decrease of the fuel injection amount calculated by the fuel injection amount calculating portion 40d is larger than the fuel injection amount decrease threshold, the in-cylinder pressure CP (Index A) detected by the in-cylinder pressure sensor 30 does not change, and an increase of the heat generation amount HR (Index B) calculated by the heat generation amount calculating portion 40a is larger than or equal to zero.

Particularly, through the diligent research, the inventors of the present disclosure have discovered that phenomena of the Index F=2 and the Index F=7 occur in each cylinder in which the abnormality occurs (Index C).

“Going off scale” in FIGS. 6 and 7 corresponds to a case in which the fuel injection amount feedback control cannot be continued on the basis of the fuel injection amount calculated by the fuel injection amount calculating portion 40d. “Going off scale and decreasing” in FIG. 6 corresponds to a case in which the fuel injection amount feedback control cannot be continued and a value of the heat generation amount HR is short. “Going off scale and increasing” in FIG. 7 corresponds to a case in which the fuel injection amount feedback control cannot be continued and the value of the heat generation amount HR is excessive.

Referring to an Index F=3 in FIG. 6, through the diligent research, the inventors of the present disclosure have discovered that when the sensitivity of the in-cylinder pressure sensor 30 does not decrease, and when the abnormality relating to a quantity of air supplied to one cylinder 14′ of the plurality of the cylinders being larger than the quantity of the air supplied to another cylinder of the plurality of the cylinders (air distribution deterioration abnormality), occurs, in said one cylinder 14′ of the plurality of the cylinders, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 increases, and the heat generation amount HR (Index B) calculated by the heat generation amount calculating portion 40a (see FIG. 2) increases.

Referring to an Index F=8 in FIG. 7, through the diligent research, the inventors of the present disclosure have discovered that when the sensitivity of the in-cylinder pressure sensor 30 does not decrease, and when the abnormality relating to the quantity of the air supplied to one cylinder 14′ of the plurality of the cylinders being smaller than the quantity of the air supplied to another cylinder of the plurality of the cylinders (air distribution deterioration abnormality), occurs, in said one cylinder 14′ of the plurality of the cylinders, the decrease of the fuel injection amount calculated by the fuel injection amount calculating portion 40d is larger than the fuel injection amount decrease threshold, the in-cylinder pressure CP (Index A) detected by the in-cylinder pressure sensor 30 decreases, and the heat generation amount HR (Index B) calculated by the heat generation amount calculating portion 40a decreases.

Particularly, through the diligent research, the inventors of the present disclosure have discovered that phenomena of the Index F=3 and the Index F=8 occur in a cylinder in which the abnormality occurs, in comparison with another cylinders in which the abnormality does not occur (Index C).

Referring to an Index F=4 in FIG. 6, through the diligent research, the inventors of the present disclosure have discovered that when the sensitivity of the in-cylinder pressure sensor 30 does not decrease, and when the abnormality relating to decrement of an air flow rate measured by the air flow meter (AFM) 44 (abnormality relating to decrement of a superficial load factor KL) occurs, in all of the plurality of the cylinders, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 increases, and the heat generation amount HR (Index B) calculated by the heat generation amount calculating portion 40a (see FIG. 2) increases.

Referring to an Index F=9 in FIG. 7, through the diligent research, the inventors of the present disclosure have discovered that when the sensitivity of the in-cylinder pressure sensor 30 does not decrease, and when the abnormality relating to increment of the air flow rate measured by the air flow meter (AFM) 44 (abnormality relating to increment of the superficial load factor KL) occurs, in all of the plurality of the cylinders, the decrease of the fuel injection amount calculated by the fuel injection amount calculating portion 40d is larger than the fuel injection amount decrease threshold, the in-cylinder pressure CP (Index A) detected by the in-cylinder pressure sensor 30 decreases, and the heat generation amount HR (Index B) calculated by the heat generation amount calculating portion 40a decreases.

Particularly, through the diligent research, the inventors of the present disclosure have discovered that phenomena of the Index F=4 and the Index F=9 occur in all cylinders (Index C).

Referring to an Index F=5 in FIG. 6, through the diligent research, the inventors of the present disclosure have discovered that when the sensitivity of the in-cylinder pressure sensor 30 does not decrease, and when the abnormality relating to decrement of a flow rate of the fuel flowing through a confluence fuel supply system (e.g. the abnormality relating to decrement of the flow rate of a fuel pump) occurs, in all of the plurality of the cylinders, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, and the decrease of the heat generation amount HR (Index B) calculated by the heat generation amount calculating portion 40a is larger than or equal to zero.

Referring to an Index F=10 in FIG. 7, through the diligent research, the inventors of the present disclosure have discovered that when the sensitivity of the in-cylinder pressure sensor 30 does not decrease, and when the abnormality relating to increment of the flow rate of the fuel flowing through the confluence fuel supply system (e.g. the abnormality relating to increment of the flow rate of the fuel pump) occurs, in all of the plurality of the cylinders, the decrease of the fuel injection amount calculated by the fuel injection amount calculating portion 40d is larger than the fuel injection amount decrease threshold, the in-cylinder pressure CP (Index A) detected by the in-cylinder pressure sensor 30 does not change, and the increase of the heat generation amount HR (Index B) calculated by the heat generation amount calculating portion 40a is larger than or equal to zero.

Particularly, through the diligent research, the inventors of the present disclosure have discovered that phenomena of the Index F=5 and the Index F=10 occur in all cylinders (Index C).

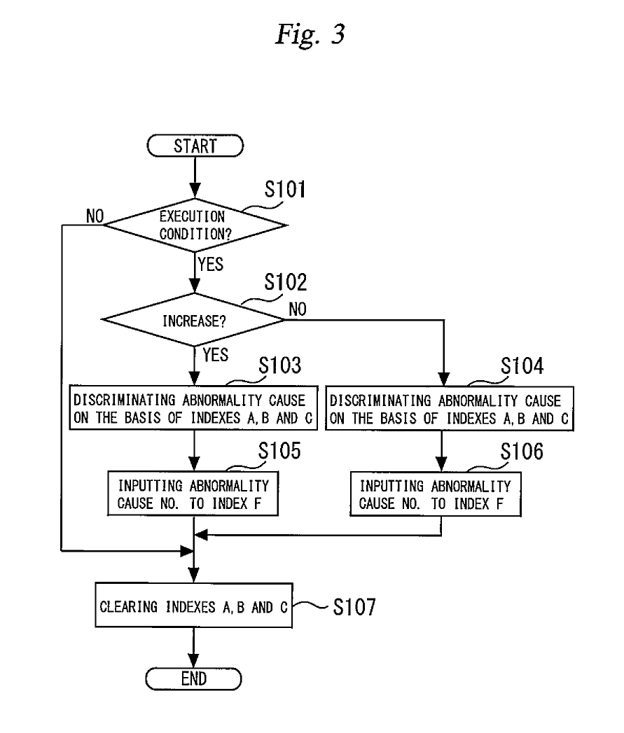

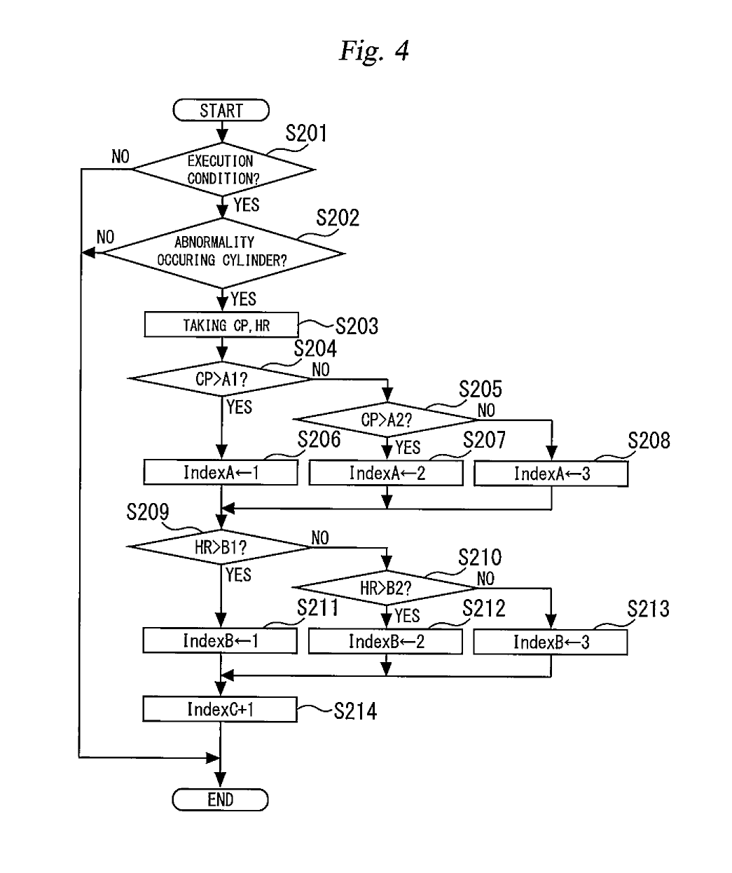

Considering the result of the diligent research shown in FIGS. 6 and 7 by the inventors of the present disclosure, in the first embodiment of the abnormality detecting device of the internal combustion engine, routines shown in FIGS. 3 and 4 are executed by the ECU 40. FIGS. 3 and 4 show flowcharts which explain the routines executed in the first embodiment of the abnormality detecting device of the internal combustion engine.

In the first embodiment of the abnormality detecting device of the internal combustion engine, an index calculating routine shown in FIG. 4 is executed in each cycle, e.g. at ATDC150CA, in each of the plurality of the cylinders. In step S201, it is judged whether an execution condition is satisfied. Concretely, it is judged whether the execution condition for discriminating the cause of the abnormality by means of an abnormality cause discriminating portion 40g (see FIG. 2) is satisfied. For example, when the fuel injection amount control (SA-CA10 control) based on the crank angle period (SA-CA10) and the injection timing control (MBT control) based on the crank angle CA50 are executed, a judgment of YES is made in step S201, and the routine goes to step S202, wherein execution of the fuel injection amount control (SA-CA10 control) and the injection timing control (MBT control) is a precondition for obtaining the result of the diligent research shown in FIGS. 6 and 7. When the SA-CA10 control and the MBT control are not executed, a judgment of NO is made in step S201, and the routine finishes.

In step S202, it is judged whether a cylinder in which the abnormality occurs, exists. Concretely, if the cylinder in which the increase of the fuel injection amount calculated by the fuel injection amount calculating portion 40d (see FIG. 2) is larger than the fuel injection amount increase threshold (particularly, the rate of the change of the fuel injection amount is larger than e.g. 1.4), exists, or if the cylinder in which the decrease of the fuel injection amount calculated by the fuel injection amount calculating portion 40d is larger than the fuel injection amount decrease threshold (particularly, the rate of the change of the fuel injection amount is smaller than e.g. 0.6), exists, it is judged that fuel system abnormality detected by the OBD occurs, and a judgment of YES is made in step S202, and the routine goes to step S203. If the cylinder in which the abnormality occurs, does not exist, a judgment of NO is made in step S202, and the routine finishes.

In step S203, the in-cylinder pressure CP (particularly, e.g. an average value of the in-cylinder pressure between BTDC40 and BTDC20 during an intake stroke) detected by the in-cylinder pressure sensor 30 (see FIG. 1) in the cylinder to which the routine is executed, and the heat generation amount HR in the cylinder, calculated by the heat generation amount calculating portion 40a (see FIG. 2) are taken.

In step S204, the in-cylinder pressure CP taken in step S203 and an in-cylinder pressure increase threshold A1 based on an air amount standard (based on a load factor KL standard) are compared. In step S205, the in-cylinder pressure CP taken in step S203 and an in-cylinder pressure decrease threshold A2 (<A1) based on the air amount standard (based on the load factor KL standard) are compared. Then, in step S206, a process showing increment of the in-cylinder pressure CP is executed (Index A←1). In step S207, a process showing that the in-cylinder pressure CP does not change is executed (Index A←2). In step S208, a process showing decrement of the in-cylinder pressure CP is executed (Index A←3).

In step S209, the heat generation amount HR taken in step S203 and a heat generation amount increase threshold B1 based on the air amount standard (based on the load factor KL standard) are compared. In step S210, the heat generation amount HR taken in step S203 and a heat generation amount decrease threshold B2 (<B1) based on the air amount standard (based on the load factor KL standard) are compared. Then, in step S211, a process showing increment of the heat generation amount HR is executed (Index B←1). In step S212, a process showing that the heat generation amount HR does not change is executed (Index B←2). In step S213, a process showing decrement of the heat generation amount HR is executed (Index B←3). Then, in step S214, the Index C which is an index showing the number of the cylinders, is increased.

Namely, the routine shown in FIG. 4 is executed in each of the plurality of the cylinders. Accordingly, the in-cylinder pressure CP which increases, does not change or decreases is obtained in each cylinder. The heat generation amount HR which increases, does not change or decreases is obtained in each cylinder.

In the first embodiment of the abnormality detecting device of the internal combustion engine, a routine shown in FIG. 3 is executed in each cycle, e.g. at TDC of a first cylinder (#1). In step S101, it is judged whether an execution condition is satisfied. Concretely, if it is judged that the fuel system abnormality detected by the OBD occurs, a judgment of YES is made, in step S101, and the routine goes to step S102. If it is judged that the fuel system abnormality detected by the OBD does not occur, a judgment of NO is made, in step S101, and the routine goes to step S107.

In step S102, it is judged whether the increase of the fuel injection amount calculated by the fuel injection amount calculating portion 40d (see FIG. 2) is larger than the fuel injection amount increase threshold (particularly, whether the rate of the change of the fuel injection amount is larger than e.g. 1.4), or whether the decrease of the fuel injection amount calculated by the fuel injection amount calculating portion 40d is larger than the fuel injection amount decrease threshold (particularly, whether the rate of the change of the fuel injection amount is smaller than e.g. 0.6). If the increase of the fuel injection amount calculated by the fuel injection amount calculating portion 40d is larger than the fuel injection amount increase threshold, the routine goes to step S103. If the decrease of the fuel injection amount calculated by the fuel injection amount calculating portion 40d is larger than the fuel injection amount decrease threshold, the routine goes to step S104.

In step S103, the cause of the abnormality is discriminated by the abnormality cause discriminating portion 40g (see FIG. 2) on the basis of the Index A (the in-cylinder pressure CP which is representative of the quantity of the intake air) obtained by executing steps S206, S207 and S208, the Index B (the heat generation amount HR which is representative of an fuel amount) obtained by executing steps S211, S212 and S213, the Index C (each cylinder or all cylinders) obtained by executing step S214, and FIG. 6. Then, in step S105, an abnormality cause number (1 to 5) (see FIG. 6) is inputted to the Index F.

In step S104, the cause of the abnormality is discriminated by the abnormality cause discriminating portion 40g (see FIG. 2) on the basis of the Index A (the in-cylinder pressure CP which is representative of the quantity of the intake air) obtained by executing steps S206, S207 and S208, the Index B (the heat generation amount HR which is representative of the fuel amount) obtained by executing steps S211, S212 and S213, the Index C (each cylinder or all cylinders) obtained by executing step S214, and FIG. 7. Then, in step S106, the abnormality cause number (6 to 10) (see FIG. 7) is inputted to the Index F. Then, in step S107, Indexes A, B and C are cleared.

Particularly, in the first embodiment of the abnormality detecting device of the internal combustion engine, if the increase of the fuel injection amount calculated by the fuel injection amount calculating portion 40d (see FIG. 2) is larger than the fuel injection amount increase threshold (see FIG. 6), if the in-cylinder pressure CP detected by the in-cylinder pressure sensor 30 does not change (Index A←2), and if the heat generation amount HR calculated by the heat generation amount calculating portion 40a (see FIG. 2) increases (Index B←1), the abnormality cause discriminating portion 40g (see FIG. 2) judges that there is a possibility that at least one of the abnormality relating to the combustion deterioration in the cylinder, and the abnormality relating to the increment of the crank angle period (SA-CA10) calculated by the crank angle period calculating portion 40c (see FIG. 2) occurs (Index F=1), wherein the abnormality relating to the increment of the crank angle period is caused by the induction noise.

If the decrease of the fuel injection amount calculated by the fuel injection amount calculating portion 40d is larger than the fuel injection amount decrease threshold (see FIG. 7), if the in-cylinder pressure CP detected by the in-cylinder pressure sensor 30 does not change (Index A←2), and if the heat generation amount HR calculated by the heat generation amount calculating portion 40a decreases (Index B←3), the abnormality cause discriminating portion 40g judges that there is a possibility that the abnormality relating to the decrement of the crank angle period (SA-CA10) calculated by the crank angle period calculating portion 40c occurs (Index F=6), wherein the abnormality relating to the decrement of the crank angle period is caused by the induction noise.

Consequently, in the first embodiment of the abnormality detecting device of the internal combustion engine, the abnormality relating to the combustion deterioration in the cylinder (Index F=1), the abnormality relating to the increment of the crank angle period (SA-CA10) calculated by the crank angle period calculating portion 40c (Index F=1), and the abnormality relating to the decrement of the crank angle period (SA-CA10) calculated by the crank angle period calculating portion 40c (Index F=6), can be discriminated from another abnormality, wherein the abnormality relating to the increment of the crank angle period and the abnormality relating to the decrement of the crank angle period are caused by the induction noise. Particularly, in the example shown in FIG. 1, in which the plurality of the cylinders are provided, one cylinder in which the abnormality occurs (Index F=1 or Index F=6) can be discriminated from another cylinders.

Also, in the first embodiment of the abnormality detecting device of the internal combustion engine, if the increase of the fuel injection amount calculated by the fuel injection amount calculating portion 40d (see FIG. 2) is larger than the fuel injection amount increase threshold (see FIG. 6), if the in-cylinder pressure CP detected by the in-cylinder pressure sensor 30 does not change (Index A←2), and if the decrease of the heat generation amount HR calculated by the heat generation amount calculating portion 40a (see FIG. 2) is larger than or equal to zero (Index B←2 or Index B←3), the abnormality cause discriminating portion 40g (see FIG. 2) judges that the abnormality relating to the decrement of the flow rate of the fuel injected from the fuel injection valve 26 occurs (Index F=2).

If the decrease of the fuel injection amount calculated by the fuel injection amount calculating portion 40d is larger than the fuel injection amount decrease threshold (see FIG. 7), if the in-cylinder pressure CP detected by the in-cylinder pressure sensor 30 does not change (Index A←2), and if the increase of the heat generation amount HR calculated by the heat generation amount calculating portion 40a is larger than or equal to zero (Index B←1 or Index B←2), the abnormality cause discriminating portion 40g judges that the abnormality relating to the increment of the flow rate of the fuel injected from the fuel injection valve 26 occurs (Index F=7).

Consequently, in the first embodiment of the abnormality detecting device of the internal combustion engine, the abnormality relating to the decrement of the flow rate of the fuel injected from the fuel injection valve 26 (Index F=2), and the abnormality relating to the increment of the flow rate of the fuel injected from the fuel injection valve 26 (Index F=7), can be discriminated from another abnormality. Particularly, in the example shown in FIG. 1, in which the plurality of the cylinders are provided, one cylinder in which the abnormality occurs (Index F=2 or Index F=7) can be discriminated from another cylinders.

Also, in the first embodiment of the abnormality detecting device of the internal combustion engine, in one cylinder of the plurality of the cylinders, if the increase of the fuel injection amount calculated by the fuel injection amount calculating portion 40d (see FIG. 2) is larger than the fuel injection amount increase threshold (see FIG. 6), if the in-cylinder pressure CP detected by the in-cylinder pressure sensor 30 increases (Index A←1), and if the heat generation amount HR calculated by the heat generation amount calculating portion 40a (see FIG. 2) increases (Index B←1), the abnormality cause discriminating portion 40g (see FIG. 2) judges that the abnormality relating to the quantity of the air supplied to said one cylinder of the plurality of the cylinders being larger than the quantity of the air supplied to another cylinder of the plurality of the cylinders, occurs (Index F=3).

In said one cylinder of the plurality of the cylinders, if the decrease of the fuel injection amount calculated by the fuel injection amount calculating portion 40d is larger than the fuel injection amount decrease threshold (see FIG. 7), if the in-cylinder pressure CP detected by the in-cylinder pressure sensor 30 decreases (Index A←3), and if the heat generation amount HR calculated by the heat generation amount calculating portion 40a decreases (Index B←3), the abnormality cause discriminating portion 40g judges that the abnormality relating to the quantity of the air supplied to said one cylinder of the plurality of the cylinders being smaller than the quantity of the air supplied to said another cylinder of the plurality of the cylinders, occurs (Index F=8).

Consequently, in the first embodiment of the abnormality detecting device of the internal combustion engine, the abnormality relating to the quantity of the air supplied to said one cylinder of the plurality of the cylinders being larger than the quantity of the air supplied to another cylinder of the plurality of the cylinders (Index F=3), and the abnormality relating to the quantity of the air supplied to said one cylinder of the plurality of the cylinders being smaller than the quantity of the air supplied to said another cylinder of the plurality of the cylinders (Index F=8), can be discriminated from another abnormality. Particularly, in the example shown in FIG. 1, in which the plurality of the cylinders are provided, one cylinder in which the abnormality occurs (Index F=3 or Index F=8) can be discriminated from another cylinders.

In the engine system, to which the first embodiment of the abnormality detecting device of the internal combustion engine is applied, shown in FIG. 1, divergent air intake passages are provided. Each of the divergent air intake passages extends from each of the plurality of the cylinders. The divergent air intake passages constitute a part of the air intake passage 16. A confluence air intake passage is formed by merging the divergent air intake passages. The confluence air intake passage constitutes a part of the air intake passage 16. The air flow meter 44 is placed in the confluence air intake passage.

Also, in the first embodiment of the abnormality detecting device of the internal combustion engine, in all of the plurality of the cylinders, if the increase of the fuel injection amount calculated by the fuel injection amount calculating portion 40d (see FIG. 2) is larger than the fuel injection amount increase threshold (see FIG. 6), if the in-cylinder pressure CP detected by the in-cylinder pressure sensor 30 increases (Index A←1), and if the heat generation amount HR calculated by the heat generation amount calculating portion 40a (see FIG. 2) increases (Index B←1), the abnormality cause discriminating portion 40g (see FIG. 2) judges that the abnormality relating to the decrement of the air flow rate measured by the air flow meter 44 occurs (Index F=4).

In said all of the plurality of the cylinders, if the decrease of the fuel injection amount calculated by the fuel injection amount calculating portion 40d is larger than the fuel injection amount decrease threshold (see FIG. 7), if the in-cylinder pressure CP detected by the in-cylinder pressure sensor 30 decreases (Index A←3), and if the heat generation amount HR calculated by the heat generation amount calculating portion 40a decreases (Index B←3), the abnormality cause discriminating portion 40g judges that the abnormality relating to the increment of the air flow rate measured by the air flow meter 44 occurs (Index F=9).

Consequently, in the first embodiment of the abnormality detecting device of the internal combustion engine, the abnormality relating to the decrement of the air flow rate measured by the air flow meter 44 (Index F=4), and the abnormality relating to the increment of the air flow rate measured by the air flow meter 44 (Index F=9), can be discriminated from another abnormality.

In the engine system, to which the first embodiment of the abnormality detecting device of the internal combustion engine is applied, shown in FIG. 1, a plurality of fuel injection valves are provided. Each of the plurality of the fuel injection valves corresponds to each cylinder. Divergent fuel supply systems (not shown) are provided. Each of the divergent fuel supply systems extends from each of the plurality of the fuel injection valves. The confluence fuel supply system (not shown) is formed by merging the divergent fuel supply systems. For example, the fuel pump (not shown) constitutes a part of the confluence fuel supply system.

Also, in the first embodiment of the abnormality detecting device of the internal combustion engine, in all of the plurality of the cylinders, if the increase of the fuel injection amount calculated by the fuel injection amount calculating portion 40d (see FIG. 2) is larger than the fuel injection amount increase threshold (see FIG. 6), if the in-cylinder pressure CP detected by the in-cylinder pressure sensor 30 does not change (Index A←2), and if the decrease of the heat generation amount HR calculated by the heat generation amount calculating portion 40a (see FIG. 2) is larger than or equal to zero (Index B←2 or Index B←3), the abnormality cause discriminating portion 40g (see FIG. 2) judges that the abnormality relating to the decrement of the flow rate of the fuel flowing through the confluence fuel supply system (e.g. the abnormality relating to the decrement of the flow rate of the fuel flowing through the fuel pump) occurs (Index F=5).

In said all of the plurality of the cylinders, if the decrease of the fuel injection amount calculated by the fuel injection amount calculating portion 40d is larger than the fuel injection amount decrease threshold (see FIG. 7), if the in-cylinder pressure CP detected by the in-cylinder pressure sensor 30 does not change (Index A←2), and if the increase of the heat generation amount HR calculated by the heat generation amount calculating portion 40a is larger than or equal to zero (Index B←1 or Index B←2), the abnormality cause discriminating portion 40g judges that the abnormality relating to the increment of the flow rate of the fuel flowing through the confluence fuel supply system (e.g. the abnormality relating to the increment of the flow rate of the fuel flowing through the fuel pump) occurs (Index F=10).

Consequently, in the first embodiment of the abnormality detecting device of the internal combustion engine, the abnormality relating to the decrement of the flow rate of the fuel flowing through the confluence fuel supply system (Index F=5), and the abnormality relating to the increment of the flow rate of the fuel flowing through the confluence fuel supply system (Index F=10), can be discriminated from another abnormality.

In other words, in the first embodiment of the abnormality detecting device of the internal combustion engine, the abnormality cause discriminating portion 40g (see FIG. 2) discriminates the cause of the abnormality on the basis of the fuel injection amount calculated by the fuel injection amount calculating portion 40d (see FIG. 2), the in-cylinder pressure CP detected by the in-cylinder pressure sensor 30, and the heat generation amount HR calculated by the heat generation amount calculating portion 40a (see FIG. 2).

Consequently, in the first embodiment of the abnormality detecting device of the internal combustion engine, the cause of the abnormality of the internal combustion engine can be discriminated, wherein the cause of the abnormality of the internal combustion engine cannot be discriminated in the internal combustion engine described in JP-A-2014-125942.

For example, if an effect of decrement of the sensitivity of the in-cylinder pressure sensor 30 is not serious, or if another technique is used in order to compensate the decrement of the sensitivity of the in-cylinder pressure sensor 30, the above-mentioned first embodiment of the abnormality detecting device of the internal combustion engine can be applied to e.g. the engine system shown in FIG. 1.

For example, if the sensitivity of the in-cylinder pressure sensor 30 decreases because of e.g. the secular change etc., and if each phenomenon (each cause of the abnormality) cannot be discriminated by Index F=1 to Index F=10 shown in FIGS. 6 and 7, a second embodiment of the abnormality detecting device of the internal combustion engine, which is mentioned below, is applied.

The second embodiment of the abnormality detecting device of the internal combustion engine of the present disclosure is explained below. In order to discriminate the cause of the abnormality which occurs in the engine system, even after the sensitivity of the in-cylinder pressure sensor 30 decreases because of e.g. the secular change etc., particularly in order to facilitate the measures (e.g. the repair) against the abnormality which occurs in the engine system, the inventors of the present disclosure have made the diligent research.

Through the diligent research, the inventors of the present disclosure have discovered that a ratio (HR/CP) of the heat generation amount HR to the in-cylinder pressure CP when the sensitivity of the in-cylinder pressure sensor 30 does not decrease, is not different from the ratio (HR/CP) of the heat generation amount HR to the in-cylinder pressure CP when the sensitivity of the in-cylinder pressure sensor 30 decreases, wherein the decrement of the sensitivity of the in-cylinder pressure sensor 30 is caused by the secular change, etc.

Through the diligent research, the inventors of the present disclosure have discovered that even when the sensitivity of the in-cylinder pressure sensor 30 decreases because of the secular change, etc., the cause of the abnormality of the internal combustion engine can be discriminated on the basis of the ratio (HR/CP) of the heat generation amount HR to the in-cylinder pressure CP.

Concretely, through the diligent research, the inventors of the present disclosure have discovered that in the engine system shown in FIG. 1, in which the in-cylinder pressure CP is detected by the in-cylinder pressure sensor 30, the heat generation amount HR is calculated on the basis of the in-cylinder pressure CP, the combustion mass percentage MFB is calculated on the basis of the heat generation amount HR, the fuel injection amount is controlled on the basis of the crank angle period (SA-CA10) from the ignition timing SA to the crank angle CA10 when the combustion mass percentage MFB reaches 10%, and the ignition timing is controlled on the basis of the crank angle CA50 when the combustion mass percentage MFB reaches 50%, the cause of the abnormality in the engine system can be discriminated by analyzing the fuel injection amount, the in-cylinder pressure CP, the heat generation amount HR and the ratio (HR/CP) of the heat generation amount HR to the in-cylinder pressure CP, when the abnormality occurs.

Namely, through the diligent research, the inventors of the present disclosure have discovered that even when the sensitivity of the in-cylinder pressure sensor 30 decreases because of e.g. the secular change, etc., and when the abnormality occurs in the engine system, it is possible to discriminate between the component which includes the abnormality and the component which does not include the abnormality, of the plurality of the components which constitutes the engine system.

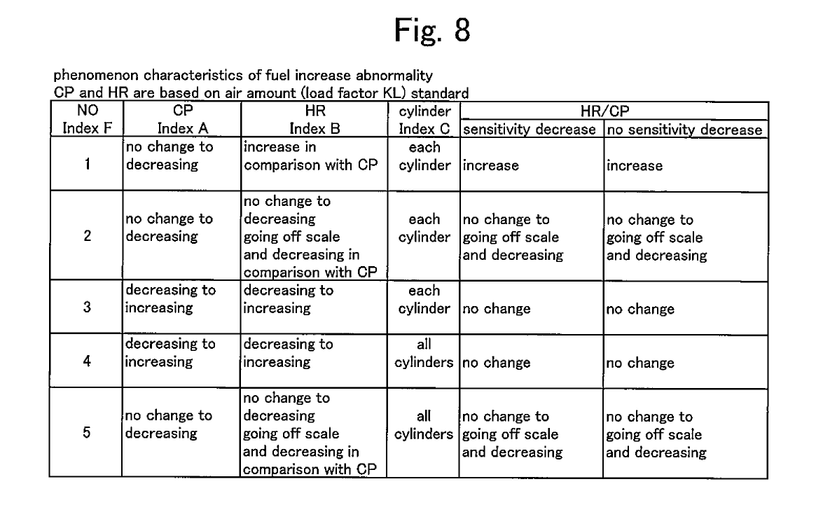

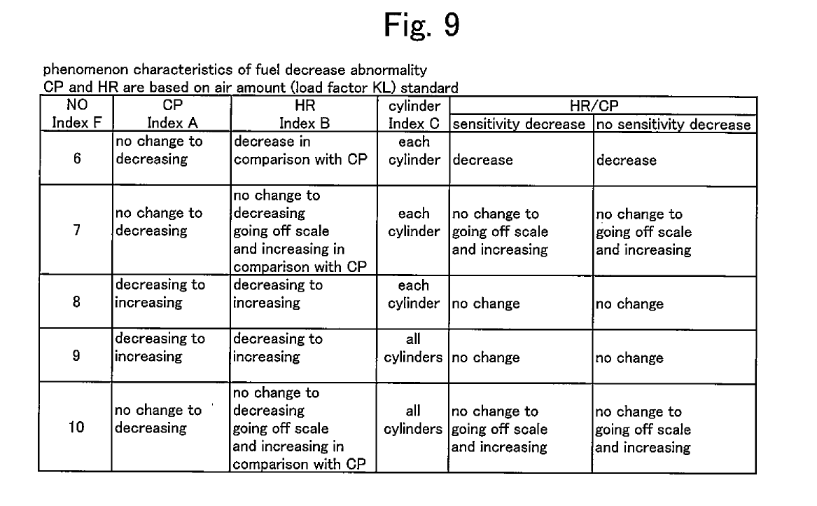

FIGS. 8 and 9 are tables which explain a result of the diligent research by the inventors of the present disclosure, when the sensitivity of the in-cylinder pressure sensor 30 does not decrease and when the sensitivity of the in-cylinder pressure sensor 30 decreases.

Referring to the Index F=1 in FIG. 8, through the diligent research, the inventors of the present disclosure have discovered that when the sensitivity of the in-cylinder pressure sensor 30 does not decrease, and when the abnormality relating to the combustion deterioration in the cylinder 14′ occurs, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, the heat generation amount HR (Index B) calculated by the heat generation amount calculating portion 40a (see FIG. 2) increases in comparison with the change of the in-cylinder pressure CP (namely, when the in-cylinder pressure CP does not change, the heat generation amount HR increases), and the ratio (HR/CP) of the heat generation amount HR to the in-cylinder pressure CP increases.

Referring to the Index F=1 in FIG. 8, through the diligent research, the inventors of the present disclosure have discovered that when the sensitivity of the in-cylinder pressure sensor 30 decreases, and when the abnormality relating to the combustion deterioration in the cylinder 14′ occurs, the increase of the fuel injection amount calculated by the fuel injection amount calculating portion 40d is larger than the fuel injection amount increase threshold, the in-cylinder pressure CP (Index A) detected by the in-cylinder pressure sensor 30 decreases, the heat generation amount HR (Index B) calculated by the heat generation amount calculating portion 40a increases in comparison with the change of the in-cylinder pressure CP (namely, when the in-cylinder pressure CP decreases, the heat generation amount HR does not change or increases), and the ratio (HR/CP) of the heat generation amount HR to the in-cylinder pressure CP increases.

Referring to the Index F=1 in FIG. 8, through the diligent research, the inventors of the present disclosure have discovered that when the sensitivity of the in-cylinder pressure sensor 30 does not decrease, and when the abnormality relating to the increment of the crank angle period (SA-CA10) calculated by the crank angle period calculating portion 40c (see FIG. 2) occurs, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, the heat generation amount HR (Index B) calculated by the heat generation amount calculating portion 40a (see FIG. 2) increases in comparison with the change of the in-cylinder pressure CP (namely, when the in-cylinder pressure CP does not change, the heat generation amount HR increases), and the ratio (HR/CP) of the heat generation amount HR to the in-cylinder pressure CP increases, wherein the abnormality relating to the increment of the crank angle period (SA-CA10) is caused by the induction noise.

Referring to the Index F=1 in FIG. 8, through the diligent research, the inventors of the present disclosure have discovered that when the sensitivity of the in-cylinder pressure sensor 30 decreases, and when the abnormality relating to the increment of the crank angle period (SA-CA 10) calculated by the crank angle period calculating portion 40c occurs, the increase of the fuel injection amount calculated by the fuel injection amount calculating portion 40d is larger than the fuel injection amount increase threshold, the in-cylinder pressure CP (Index A) detected by the in-cylinder pressure sensor 30 decreases, the heat generation amount HR (Index B) calculated by the heat generation amount calculating portion 40a (see FIG. 2) increases in comparison with the change of the in-cylinder pressure CP (namely, when the in-cylinder pressure CP decreases, the heat generation amount HR does not change or increases), and the ratio (HR/CP) of the heat generation amount HR to the in-cylinder pressure CP increases, wherein the abnormality relating to the increment of the crank angle period (SA-CA10) is caused by the induction noise.

Referring to the Index F=6 in FIG. 9, through the diligent research, the inventors of the present disclosure have discovered that when the sensitivity of the in-cylinder pressure sensor 30 does not decrease, and when the abnormality relating to the decrement of the crank angle period (SA-CA10) calculated by the crank angle period calculating portion 40c (see FIG. 2) occurs, the decrease of the fuel injection amount calculated by the fuel injection amount calculating portion 40d (see FIG. 2) is larger than the fuel injection amount decrease threshold, the in-cylinder pressure CP (Index A) detected by the in-cylinder pressure sensor 30 does not change, the heat generation amount HR (Index B) calculated by the heat generation amount calculating portion 40a (see FIG. 2) decreases in comparison with the change of the in-cylinder pressure CP (namely, when the in-cylinder pressure CP does not change, the heat generation amount HR decreases), and the ratio (HR/CP) of the heat generation amount HR to the in-cylinder pressure CP decreases, wherein the abnormality relating to the decrement of the crank angle period (SA-CA10) is caused by the induction noise.

Referring to the Index F=6 in FIG. 9, through the diligent research, the inventors of the present disclosure have discovered that when the sensitivity of the in-cylinder pressure sensor 30 decreases, and when the abnormality relating to the decrement of the crank angle period (SA-CA10) calculated by the crank angle period calculating portion 40c occurs, the decrease of the fuel injection amount calculated by the fuel injection amount calculating portion 40d is larger than the fuel injection amount decrease threshold, the in-cylinder pressure CP (Index A) detected by the in-cylinder pressure sensor 30 decreases, the heat generation amount HR (Index B) calculated by the heat generation amount calculating portion 40a decreases in comparison with the change of the in-cylinder pressure CP (namely, when the in-cylinder pressure CP decreases, the heat generation amount HR also decreases, wherein a degree of decrement of the heat generation amount HR is larger than a degree of decrement of the in-cylinder pressure CP), and the ratio (HR/CP) of the heat generation amount HR to the in-cylinder pressure CP decreases, wherein the abnormality relating to the decrement of the crank angle period (SA-CA10) is caused by the induction noise.

Referring to the Index F=2 in FIG. 8, through the diligent research, the inventors of the present disclosure have discovered that when the sensitivity of the in-cylinder pressure sensor 30 does not decrease, and when the abnormality relating to the decrement of the flow rate of the fuel injected from the fuel injection valve 26 occurs, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, the decrease of the heat generation amount HR (Index B) calculated by the heat generation amount calculating portion 40a (see FIG. 2) is larger than or equal to zero, the heat generation amount HR (Index B) calculated by the heat generation amount calculating portion 40a decreases in comparison with the change of the in-cylinder pressure CP (namely, for example, when the in-cylinder pressure CP does not change, the heat generation amount HR does not change), and a decrease of the ratio (HR/CP) of the heat generation amount HR to the in-cylinder pressure CP is larger than or equal to zero.

Referring to the Index F=2 in FIG. 8, through the diligent research, the inventors of the present disclosure have discovered that when the sensitivity of the in-cylinder pressure sensor 30 decreases, and when the abnormality relating to the decrement of the flow rate of the fuel injected from the fuel injection valve 26 occurs, the increase of the fuel injection amount calculated by the fuel injection amount calculating portion 40d is larger than the fuel injection amount increase threshold, the in-cylinder pressure CP detected by the in-cylinder pressure sensor 30 decreases, the decrease of the heat generation amount HR (Index B) calculated by the heat generation amount calculating portion 40a is larger than or equal to zero, the heat generation amount HR (Index B) calculated by the heat generation amount calculating portion 40a decreases in comparison with the change of the in-cylinder pressure CP (namely, when the in-cylinder pressure CP decreases, the heat generation amount HR also decreases, wherein the degree of the decrement of the heat generation amount HR is larger than the degree of the decrement of the in-cylinder pressure CP), and the decrease of the ratio (HR/CP) of the heat generation amount HR to the in-cylinder pressure CP is larger than or equal to zero.

Referring to the Index F=7 in FIG. 9, through the diligent research, the inventors of the present disclosure have discovered that when the sensitivity of the in-cylinder pressure sensor 30 does not decrease, and when the abnormality relating to the increment of the flow rate of the fuel injected from the fuel injection valve 26 occurs, the decrease of the fuel injection amount calculated by the fuel injection amount calculating portion 40d (see FIG. 2) is larger than the fuel injection amount decrease threshold, the in-cylinder pressure CP (Index A) detected by the in-cylinder pressure sensor 30 does not change, the decrease of the heat generation amount HR (Index B) calculated by the heat generation amount calculating portion 40a (see FIG. 2) is larger than or equal to zero, the heat generation amount HR (Index B) calculated by the heat generation amount calculating portion 40a increases in comparison with the change of the in-cylinder pressure CP (namely, for example, when the in-cylinder pressure CP does not change, the heat generation amount HR does not change), and an increase of the ratio (HR/CP) of the heat generation amount HR to the in-cylinder pressure CP is larger than or equal to zero.

Referring to the Index F=7 in FIG. 9, through the diligent research, the inventors of the present disclosure have discovered that when the sensitivity of the in-cylinder pressure sensor 30 decreases, and when the abnormality relating to the increment of the flow rate of the fuel injected from the fuel injection valve 26 occurs, the decrease of the fuel injection amount calculated by the fuel injection amount calculating portion 40d is larger than the fuel injection amount decrease threshold, the in-cylinder pressure CP (Index A) detected by the in-cylinder pressure sensor 30 decreases, the decrease of the heat generation amount HR (Index B) calculated by the heat generation amount calculating portion 40a is larger than or equal to zero, the heat generation amount HR (Index B) calculated by the heat generation amount calculating portion 40a increases in comparison with the change of the in-cylinder pressure CP (namely, when the in-cylinder pressure CP decreases, the heat generation amount HR does not change, or when the in-cylinder pressure CP decreases, the heat generation amount HR also decreases and the degree of the decrement of the heat generation amount HR is smaller than the degree of the decrement of the in-cylinder pressure CP), and the increase of the ratio (HR/CP) of the heat generation amount HR to the in-cylinder pressure CP is larger than or equal to zero.

Referring to the Index F=5 in FIG. 8, through the diligent research, the inventors of the present disclosure have discovered that when the sensitivity of the in-cylinder pressure sensor 30 does not decrease, and when the abnormality relating to the decrement of the flow rate of the fuel flowing through the confluence fuel supply system (e.g. the abnormality relating to the decrement of the flow rate of the fuel pump) occurs, in all of the plurality of the cylinders, the increase of the fuel injection amount calculated by the fuel injection amount calculating portion 40d (see FIG. 2) is larger than the fuel injection amount increase threshold, the in-cylinder pressure CP (Index A) detected by the in-cylinder pressure sensor 30 does not change, the decrease of the heat generation amount HR (Index B) calculated by the heat generation amount calculating portion 40a (see FIG. 2) is larger than or equal to zero, the heat generation amount HR (Index B) calculated by the heat generation amount calculating portion 40a decreases in comparison with the change of the in-cylinder pressure CP (namely, for example, when the in-cylinder pressure CP does not change, the heat generation amount HR does not change), and the decrease of the ratio (HR/CP) of the heat generation amount HR to the in-cylinder pressure CP is larger than or equal to zero.

Referring to the Index F=5 in FIG. 8, through the diligent research, the inventors of the present disclosure have discovered that when the sensitivity of the in-cylinder pressure sensor 30 decreases, and when the abnormality relating to the decrement of the flow rate of the fuel flowing through the confluence fuel supply system (e.g. the abnormality relating to the decrement of the flow rate of the fuel pump) occurs, in all of the plurality of the cylinders, the increase of the fuel injection amount calculated by the fuel injection amount calculating portion 40d is larger than the fuel injection amount increase threshold, the in-cylinder pressure CP (Index A) detected by the in-cylinder pressure sensor 30 decreases, the decrease of the heat generation amount HR (Index B) calculated by the heat generation amount calculating portion 40a is larger than or equal to zero, the heat generation amount HR (Index B) calculated by the heat generation amount calculating portion 40a decreases in comparison with the change of the in-cylinder pressure CP (namely, when the in-cylinder pressure CP decreases, the heat generation amount HR also decreases, wherein the degree of the decrement of the heat generation amount HR is larger than the degree of the decrement of the in-cylinder pressure CP), and the decrease of the ratio (HR/CP) of the heat generation amount HR to the in-cylinder pressure CP is larger than or equal to zero.

Referring to the Index F=10 in FIG. 9, through the diligent research, the inventors of the present disclosure have discovered that when the sensitivity of the in-cylinder pressure sensor 30 does not decrease, and when the abnormality relating to the increment of the flow rate of the fuel flowing through the confluence fuel supply system (e.g. the abnormality relating to the increment of the flow rate of the fuel pump) occurs, in all of the plurality of the cylinders, the decrease of the fuel injection amount calculated by the fuel injection amount calculating portion 40d (see FIG. 2) is larger than the fuel injection amount decrease threshold, the in-cylinder pressure CP (Index A) detected by the in-cylinder pressure sensor 30 does not change, the decrease of the heat generation amount HR (Index B) calculated by the heat generation amount calculating portion 40a (see FIG. 2) is larger than or equal to zero, the heat generation amount HR (Index B) calculated by the heat generation amount calculating portion 40a increases in comparison with the change of the in-cylinder pressure CP (namely, for example, when the in-cylinder pressure CP does not change, the heat generation amount HR does not change), and the increase of the ratio (HR/CP) of the heat generation amount HR to the in-cylinder pressure CP is larger than or equal to zero.

Referring to the Index F=10 in FIG. 9, through the diligent research, the inventors of the present disclosure have discovered that when the sensitivity of the in-cylinder pressure sensor 30 decreases, and when the abnormality relating to the increment of the flow rate of the fuel flowing through the confluence fuel supply system (e.g. the abnormality relating to the increment of the flow rate of the fuel pump) occurs, in all of the plurality of the cylinders, the decrease of the fuel injection amount calculated by the fuel injection amount calculating portion 40d is larger than the fuel injection amount decrease threshold, the in-cylinder pressure CP (Index A) detected by the in-cylinder pressure sensor 30 decreases, the decrease of the heat generation amount HR (Index B) calculated by the heat generation amount calculating portion 40a is larger than or equal to zero, the heat generation amount HR (Index B) calculated by the heat generation amount calculating portion 40a increases in comparison with the change of the in-cylinder pressure CP (namely, when the in-cylinder pressure CP decreases, the heat generation amount HR does not change, or when the in-cylinder pressure CP decreases, the heat generation amount HR also decreases and the degree of the decrement of the heat generation amount HR is smaller than the degree of the decrement of the in-cylinder pressure CP), and the increase of the ratio (HR/CP) of the heat generation amount HR to the in-cylinder pressure CP is larger than or equal to zero.

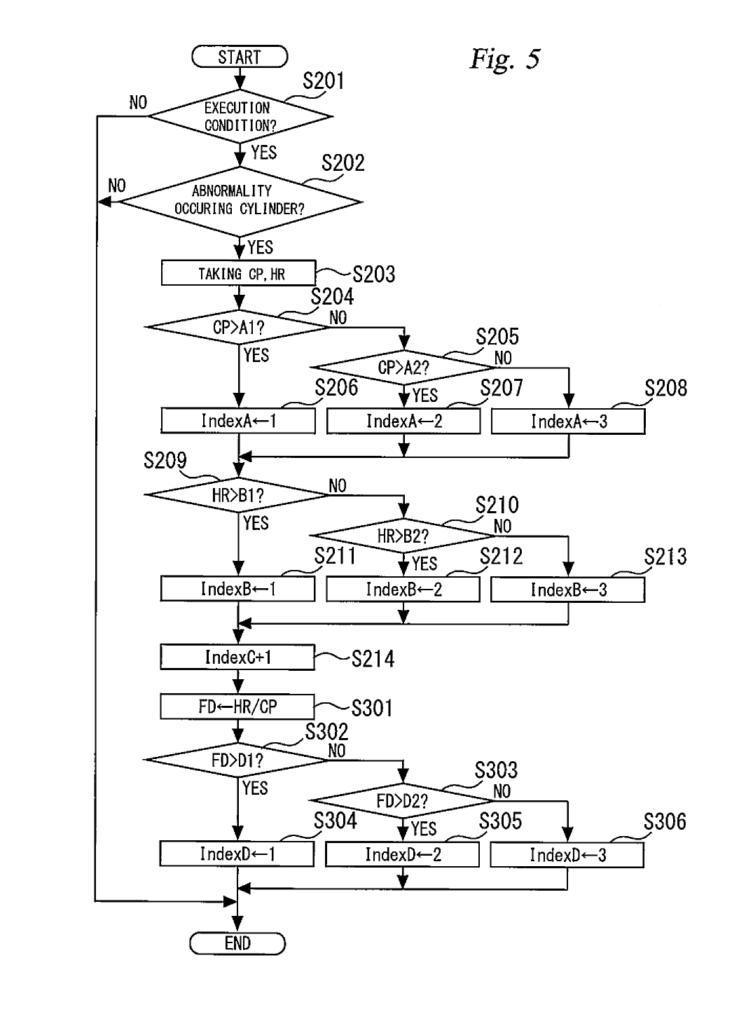

Considering the result of the diligent research shown in FIGS. 8 and 9 by the inventors of the present disclosure, in the second embodiment of the abnormality detecting device of the internal combustion engine, a routine shown in FIG. 5 is executed by the ECU 40. FIG. 5 shows a flowchart which explains the routine executed in the second embodiment of the abnormality detecting device of the internal combustion engine.

In the second embodiment of the abnormality detecting device of the internal combustion engine, an index calculating routine shown in FIG. 5 is executed in each cycle, e.g. at ATDC150CA, in each of the plurality of the cylinders. In step S201, it is judged whether an execution condition is satisfied. Concretely, it is judged whether the execution condition for discriminating the cause of the abnormality by means of the abnormality cause discriminating portion 40g (see FIG. 2) is satisfied. For example, when the fuel injection amount control (SA-CA10 control) based on the crank angle period (SA-CA10) and the injection timing control (MBT control) based on the crank angle CA50 are executed, a judgment of YES is made in step S201, and the routine goes to step S202, wherein execution of the fuel injection amount control (SA-CA10 control) and the injection timing control (MBT control) is a precondition for obtaining the result of the diligent research shown in FIGS. 8 and 9. When the SA-CA10 control and the MBT control are not executed, a judgment of NO is made in step S201, and the routine finishes.

In step S202, it is judged whether a cylinder in which the abnormality occurs, exists. Concretely, if the cylinder in which the increase of the fuel injection amount calculated by the fuel injection amount calculating portion 40d (see FIG. 2) is larger than the fuel injection amount increase threshold (particularly, the rate of the change of the fuel injection amount is larger than e.g. 1.4), exists, or if the cylinder in which the decrease of the fuel injection amount calculated by the fuel injection amount calculating portion 40d is larger than the fuel injection amount decrease threshold (particularly, the rate of the change of the fuel injection amount is smaller than e.g. 0.6), exists, it is judged that the fuel system abnormality detected by the OBD occurs, and a judgment of YES is made in step S202, and the routine goes to step S203. If the cylinder in which the abnormality occurs, does not exist, a judgment of NO is made in step S202, and the routine finishes.

In step S203, the in-cylinder pressure CP (particularly, e.g. the average value of the in-cylinder pressure between BTDC40 and BTDC20 during the intake stroke) detected by the in-cylinder pressure sensor 30 (see FIG. 1) in the cylinder to which the routine is executed, and the heat generation amount HR in the cylinder, calculated by the heat generation amount calculating portion 40a (see FIG. 2) are taken.

In step S204, the in-cylinder pressure CP taken in step S203 and the in-cylinder pressure increase threshold A1 based on the air amount standard (based on the load factor KL standard) are compared. In step S205, the in-cylinder pressure CP taken in step S203 and the in-cylinder pressure decrease threshold A2 (<A1) based on the air amount standard (based on the load factor KL standard) are compared. Then, in step S206, the process showing the increment of the in-cylinder pressure CP is executed (Index A←1). In step S207, the process showing that the in-cylinder pressure CP does not change is executed (Index A←2). In step S208, the process showing the decrement of the in-cylinder pressure CP is executed (Index A←3).

In step S209, the heat generation amount HR taken in step S203 and the heat generation amount increase threshold B1 based on the air amount standard (based on the load factor KL standard) are compared. In step S210, the heat generation amount HR taken in step S203 and the heat generation amount decrease threshold B2 (<B1) based on the air amount standard (based on the load factor KL standard) are compared. Then, in step S211, the process showing the increment of the heat generation amount HR is executed (Index B←1). In step S212, the process showing that the heat generation amount HR does not change is executed (Index B←2). In step S213, the process showing the decrement of the heat generation amount HR is executed (Index B←3). Then, in step S214, the Index C which is the index showing the number of the cylinders, is increased.

In step S301, the ratio (HR/CP) of the heat generation amount HR to the in-cylinder pressure CP in the cylinder to which the routine is executed, is calculated, and a value FD is set by the ratio (HR/CP)(FD←HR/CP). In step S302, the value FD calculated in step S301 and showing the ratio (HR/CP) of the heat generation amount HR to the in-cylinder pressure CP, and a ratio increase threshold D1 are compared. In step S303, the value FD calculated in step S301 and showing the ratio (HR/CP) of the heat generation amount HR to the in-cylinder pressure CP, and a ratio decrease threshold D2 (<D1) are compared.

In step S304, a process showing increment of the value FD showing the ratio (HR/CP) of the heat generation amount HR to the in-cylinder pressure CP is executed (Index D←1). In step S305, a process showing that the value FD showing the ratio (HR/CP) of the heat generation amount HR to the in-cylinder pressure CP does not change is executed (Index D←2). In step S306, a process showing decrement of the value FD showing the ratio (HR/CP) of the heat generation amount HR to the in-cylinder pressure CP is executed (Index D←3).

Namely, the routine shown in FIG. 5 is executed in each of the plurality of the cylinders. Accordingly, the in-cylinder pressure CP which increases, does not change or decreases is obtained in each cylinder. The heat generation amount HR which increases, does not change or decreases is obtained in each cylinder. The ratio (HR/CP) of the heat generation amount HR to the in-cylinder pressure CP, which increases, does not change or decreases is obtained in each cylinder.

In the second embodiment of the abnormality detecting device of the internal combustion engine, a routine (not shown) corresponding to the routine shown in FIG. 3 is executed in each cycle, e.g. at the TDC of the first cylinder (#1). In step corresponding to step S101 (see FIG. 3), it is judged whether the execution condition is satisfied. Concretely, if it is judged that the fuel system abnormality detected by the OBD occurs, a judgment of YES is made, in step corresponding to step S101, and the routine goes to step corresponding to step S102 (see FIG. 3). If it is judged that the fuel system abnormality detected by the OBD does not occur, a judgment of NO is made, in step corresponding to step S101, and the routine goes to step corresponding to step S107 (see FIG. 3).

In step corresponding to step S102, it is judged whether the increase of the fuel injection amount calculated by the fuel injection amount calculating portion 40d (see FIG. 2) is larger than the fuel injection amount increase threshold (particularly, whether the rate of the change of the fuel injection amount is larger than e.g. 1.4), or whether the decrease of the fuel injection amount calculated by the fuel injection amount calculating portion 40d is larger than the fuel injection amount decrease threshold (particularly, whether the rate of the change of the fuel injection amount is smaller than e.g. 0.6). If the increase of the fuel injection amount calculated by the fuel injection amount calculating portion 40d is larger than the fuel injection amount increase threshold, the routine goes to step corresponding to step S103 (see FIG. 3). If the decrease of the fuel injection amount calculated by the fuel injection amount calculating portion 40d is larger than the fuel injection amount decrease threshold, the routine goes to step corresponding to step S104 (see FIG. 3).

In step corresponding to step S103 (see FIG. 3), the cause of the abnormality is discriminated by the abnormality cause discriminating portion 40g (see FIG. 2) on the basis of the Index A (the in-cylinder pressure CP which is representative of the quantity of the intake air) obtained by executing steps S206, S207 and S208 (see FIG. 5), the Index B (the heat generation amount HR which is representative of the fuel amount) obtained by executing steps S211, S212 and S213 (see FIG. 5), the Index C (each cylinder or all cylinders) obtained by executing step S214 (see FIG. 5), the Index D (the ratio (HR/CP) of the heat generation amount HR to the in-cylinder pressure CP) obtained by executing steps S304, S305 and S306 (see FIG. 5), and FIG. 8. Then, in step corresponding to step S105 (see FIG. 3), the abnormality cause number (1 to 5) (see FIG. 8) is inputted to the Index F.

In step corresponding to step S104 (see FIG. 3), the cause of the abnormality is discriminated by the abnormality cause discriminating portion 40g (see FIG. 2) on the basis of the Index A (the in-cylinder pressure CP which is representative of the quantity of the intake air) obtained by executing steps S206, S207 and S208 (see FIG. 5), the Index B (the heat generation amount HR which is representative of the fuel amount) obtained by executing steps S211, S212 and S213 (see FIG. 5), the Index C (each cylinder or all cylinders) obtained by executing step S214 (see FIG. 5), the Index D (the ratio (HR/CP) of the heat generation amount HR to the in-cylinder pressure CP) obtained by executing steps S304, S305 and S306 (see FIG. 5), and FIG. 9. Then, in step corresponding to step S106 (see FIG. 3), the abnormality cause number (6 to 10) (see FIG. 9) is inputted to the Index F. Then, in step corresponding to step S107 (see FIG. 3), Indexes A, B, C and D are cleared.

Particularly, in the second embodiment of the abnormality detecting device of the internal combustion engine, if the increase of the fuel injection amount calculated by the fuel injection amount calculating portion 40d (see FIG. 2) is larger than the fuel injection amount increase threshold (see FIG. 8), if a decrease of the in-cylinder pressure CP detected by the in-cylinder pressure sensor 30 is larger than or equal to zero (Index A←2 or Index A←3), if the heat generation amount HR calculated by the heat generation amount calculating portion 40a (see FIG. 2) increases in comparison with the change of the in-cylinder pressure CP (Index A←2 and Index B←1, or, Index A←3 and Index B←2), and if the ratio (HR/CP) of the heat generation amount HR to the in-cylinder pressure CP increases (Index D←1), the abnormality cause discriminating portion 40g (see FIG. 2) judges that there is a possibility that at least one of the abnormality relating to the combustion deterioration in the cylinder, and the abnormality relating to the increment of the crank angle period (SA-CA10) calculated by the crank angle period calculating portion 40c (see FIG. 2) occurs (Index F=1), wherein the abnormality relating to the increment of the crank angle period is caused by the induction noise.

If the decrease of the fuel injection amount calculated by the fuel injection amount calculating portion 40d is larger than the fuel injection amount decrease threshold (see FIG. 9), if the decrease of the in-cylinder pressure CP detected by the in-cylinder pressure sensor 30 is larger than or equal to zero (Index A←2), if the heat generation amount HR calculated by the heat generation amount calculating portion 40a decreases in comparison with the change of the in-cylinder pressure CP (Index A←2 and Index B←3), and if the ratio (HR/CP) of the heat generation amount HR to the in-cylinder pressure CP decreases (Index D←3), the abnormality cause discriminating portion 40g judges that there is a possibility that the abnormality relating to the decrement of the crank angle period (SA-CA10) calculated by the crank angle period calculating portion 40c occurs (Index F=6), wherein the abnormality relating to the decrement of the crank angle period is caused by the induction noise.

Consequently, in the second embodiment of the abnormality detecting device of the internal combustion engine, even when the sensitivity of the in-cylinder pressure sensor 30 decreases because of the secular change, etc., the abnormality relating to the combustion deterioration in the cylinder 14′ (Index F=1), the abnormality relating to the increment of the crank angle period (SA-CA10) calculated by the crank angle period calculating portion 40c (Index F=1), and the abnormality relating to the decrement of the crank angle period (SA-CA10) calculated by the crank angle period calculating portion 40c (Index F=6), can be discriminated from another abnormality, wherein the abnormality relating to the increment of the crank angle period and the abnormality relating to the decrement of the crank angle period are caused by the induction noise. Particularly, in the example shown in FIG. 1, in which the plurality of the cylinders are provided, one cylinder in which the abnormality occurs (Index F=1 or Index F=6) can be discriminated from another cylinders.

Also, in the second embodiment of the abnormality detecting device of the internal combustion engine, if the increase of the fuel injection amount calculated by the fuel injection amount calculating portion 40d (see FIG. 2) is larger than the fuel injection amount increase threshold (see FIG. 8), if the decrease of the in-cylinder pressure CP detected by the in-cylinder pressure sensor 30 is larger than or equal to zero (Index A←2), if the decrease of the heat generation amount HR calculated by the heat generation amount calculating portion 40a (see FIG. 2) is larger than or equal to zero, if the heat generation amount HR calculated by the heat generation amount calculating portion 40a decreases in comparison with the change of the in-cylinder pressure CP (Index A←2 and Index B←3), and if the decrease of the ratio (HR/CP) of the heat generation amount HR to the in-cylinder pressure CP is larger than or equal to zero (Index D←2 or Index D←3), the abnormality cause discriminating portion 40g (see FIG. 2) judges that the abnormality relating to the decrement of the flow rate of the fuel injected from the fuel injection valve 26 occurs (Index F=2).

If the decrease of the fuel injection amount calculated by the fuel injection amount calculating portion 40d is larger than the fuel injection amount decrease threshold (see FIG. 9), if the decrease of the in-cylinder pressure CP detected by the in-cylinder pressure sensor 30 is larger than or equal to zero (Index A←3), if the decrease of the heat generation amount HR calculated by the heat generation amount calculating portion 40a is larger than or equal to zero, if the heat generation amount HR calculated by the heat generation amount calculating portion 40a increases in comparison with the change of the in-cylinder pressure CP (Index A←3 and Index B←2), and if the increase of the ratio (HR/CP) of the heat generation amount HR to the in-cylinder pressure CP is larger than or equal to zero (Index D←1 or Index D←2), the abnormality cause discriminating portion 40g judges that the abnormality relating to the increment of the flow rate of the fuel injected from the fuel injection valve 26 occurs (Index F=7).

Consequently, in the second embodiment of the abnormality detecting device of the internal combustion engine, even when the sensitivity of the in-cylinder pressure sensor 30 decreases because of the secular change, etc., the abnormality relating to the decrement of the flow rate of the fuel injected from the fuel injection valve 26 (Index F=2), and the abnormality relating to the increment of the flow rate of the fuel injected from the fuel injection valve 26 (Index F=7), can be discriminated from another abnormality. Particularly, in the example shown in FIG. 1, in which the plurality of the cylinders are provided, one cylinder in which the abnormality occurs (Index F=2 or Index F=7) can be discriminated from another cylinders.

Also, in the second embodiment of the abnormality detecting device of the internal combustion engine, in all of the plurality of the cylinders, if the increase of the fuel injection amount calculated by the fuel injection amount calculating portion 40d (see FIG. 2) is larger than the fuel injection amount increase threshold (see FIG. 8), if the decrease of the in-cylinder pressure CP detected by the in-cylinder pressure sensor 30 is larger than or equal to zero (Index A←2), if the decrease of the heat generation amount HR calculated by the heat generation amount calculating portion 40a (see FIG. 2) is larger than or equal to zero, if the heat generation amount HR calculated by the heat generation amount calculating portion 40a decreases in comparison with the change of the in-cylinder pressure CP (Index A←2 and Index B←3), and if the decrease of the ratio (HR/CP) of the heat generation amount HR to the in-cylinder pressure CP is larger than or equal to zero (Index D←2 or Index D←3), the abnormality cause discriminating portion 40g (see FIG. 2) judges that the abnormality relating to the decrement of the flow rate of the fuel flowing through the confluence fuel supply system occurs (Index F=5).

In said all of the plurality of the cylinders, if the decrease of the fuel injection amount calculated by the fuel injection amount calculating portion 40d is larger than the fuel injection amount decrease threshold (see FIG. 9), if the decrease of the in-cylinder pressure CP detected by the in-cylinder pressure sensor 30 is larger than or equal to zero (Index A←3), if the decrease of the heat generation amount HR calculated by the heat generation amount calculating portion 40a is larger than or equal to zero, if the heat generation amount HR calculated by the heat generation amount calculating portion 40a increases in comparison with the change of the in-cylinder pressure CP (Index A←3 and Index B←2), and if the increase of the ratio (HR/CP) of the heat generation amount HR to the in-cylinder pressure CP is larger than or equal to zero (Index D←1 or Index D←2), the abnormality cause discriminating portion 40g judges that the abnormality relating to the increment of the flow rate of the fuel flowing through the confluence fuel supply system occurs (Index F=10).

Consequently, in the second embodiment of the abnormality detecting device of the internal combustion engine, even when the sensitivity of the in-cylinder pressure sensor 30 decreases because of the secular change, etc., the abnormality relating to the decrement of the flow rate of the fuel flowing through the confluence fuel supply system (Index F=5), and the abnormality relating to the increment of the flow rate of the fuel flowing through the confluence fuel supply system (Index F=10), can be discriminated from another abnormality.

In an example shown in FIG. 4, the threshold A1 and the threshold A2 relating to the in-cylinder pressure CP are set, and the threshold B1 and the threshold B2 relating to the heat generation amount HR are set. In another example, in order to analyze a phenomenon in detail, in which the heat generation amount HR increases in comparison with the change of the in-cylinder pressure CP, and in order to analyze a phenomenon in detail, in which the heat generation amount HR decreases in comparison with the change of the in-cylinder pressure CP, more than two thresholds relating to the in-cylinder pressure CP can be set, and more than two thresholds relating to the heat generation amount HR can be set.

In a third embodiment, the first and second embodiments mentioned above and the examples mentioned above can be combined appropriately.

Obviously many modifications and variations of the present disclosure are possible in the light of the above teachings. It is therefore to be understood that within the scope of the appended claims, the invention may be practiced otherwise than as specifically described.

The entire disclosure of Japanese Patent Application No. 2015-118249, filed on Jun. 11, 2015 including specification, claims, drawings and summary, on which the Convention priority of the present application is based, is incorporated herein by reference in its entirety.

1. An abnormality detecting device of an internal combustion engine, comprising:
a cylinder;
an in-cylinder pressure sensor for detecting an in-cylinder pressure, the in-cylinder pressure being a combustion pressure in the cylinder;
a spark plug placed in the cylinder;
a fuel injection valve;
a crank angle sensor;
a heat generation amount calculating portion for calculating a heat generation amount on the basis of the in-cylinder pressure detected by the in-cylinder pressure sensor;
a combustion mass percentage calculating portion for calculating a combustion mass percentage on the basis of the heat generation amount calculated by the heat generation amount calculating portion;
a crank angle period calculating portion for calculating a crank angle period from ignition timing of the spark plug to when the combustion mass percentage reaches a first value on the basis of crank angles detected by the crank angle sensor;
a fuel injection amount calculating portion for calculating a fuel injection amount injected from the fuel injection valve on the basis of the crank angle period calculated by the crank angle period calculating portion;
a crank angle calculating portion for calculating a crank angle when the combustion mass percentage reaches a second value;
an ignition timing calculating portion for calculating the ignition timing on the basis of the crank angle calculated by the crank angle calculating portion; and
an abnormality cause discriminating portion for discriminating a cause of abnormality on the basis of the fuel injection amount calculated by the fuel injection amount calculating portion, the in-cylinder pressure detected by the in-cylinder pressure sensor, and the heat generation amount calculated by the heat generation amount calculating portion.

2. The abnormality detecting device of the internal combustion engine according to claim 1, wherein if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the in-cylinder pressure detected by the in-cylinder pressure sensor is larger than an in-cylinder pressure decrease threshold, and if the heat generation amount calculated by the heat generation amount calculating portion is larger than a heat generation amount increase threshold, the abnormality cause discriminating portion judges that there is a possibility that at least one of the abnormality relating to combustion deterioration in the cylinder, and the abnormality relating to increment of the crank angle period calculated by the crank angle period calculating portion occurs, wherein the abnormality relating to the increment of the crank angle period is caused by an induction noise, and wherein if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is smaller than or equal to a heat generation amount decrease threshold, the abnormality cause discriminating portion judges that there is a possibility that the abnormality relating to decrement of the crank angle period calculated by the crank angle period calculating portion occurs, wherein the abnormality relating to the decrement of the crank angle period is caused by the induction noise.

3. The abnormality detecting device of the internal combustion engine according to claim 1, wherein if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the in-cylinder pressure detected by the in-cylinder pressure sensor is larger than an in-cylinder pressure decrease threshold, and if the heat generation amount calculated by the heat generation amount calculating portion is smaller than or equal to a heat generation amount increase threshold, the abnormality cause discriminating portion judges that the abnormality relating to decrement of a flow rate of fuel injected from the fuel injection valve occurs, and wherein if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is larger than a heat generation amount decrease threshold, the abnormality cause discriminating portion judges that the abnormality relating to increment of the flow rate of the fuel injected from the fuel injection valve occurs.

4. The abnormality detecting device of the internal combustion engine according to claim 1, further comprising a plurality of cylinders, wherein in one cylinder of the plurality of the cylinders, if an increase of the fuel injection amount calculated by the fuel injection amount calculating portion is larger than a fuel injection amount increase threshold, if the in-cylinder pressure detected by the in-cylinder pressure sensor is larger than an in-cylinder pressure increase threshold, and if the heat generation amount calculated by the heat generation amount calculating portion is larger than a heat generation amount increase threshold, the abnormality cause discriminating portion judges that the abnormality relating to a quantity of air supplied to said one cylinder of the plurality of the cylinders being larger than the quantity of the air supplied to another cylinder of the plurality of the cylinders, occurs, and wherein in said one cylinder of the plurality of the cylinders, if a decrease of the fuel injection amount calculated by the fuel injection amount calculating portion is larger than a fuel injection amount decrease threshold, if the in-cylinder pressure detected by the in-cylinder pressure sensor is smaller than or equal to an in-cylinder pressure decrease threshold, and if the heat generation amount calculated by the heat generation amount calculating portion is smaller than or equal to a heat generation amount decrease threshold, the abnormality cause discriminating portion judges that the abnormality relating to the quantity of the air supplied to said one cylinder of the plurality of the cylinders being smaller than the quantity of the air supplied to said another cylinder of the plurality of the cylinders, occurs.

5. The abnormality detecting device of the internal combustion engine according to claim 1, further comprising:
a plurality of cylinders;
divergent air intake passages, each of the divergent air intake passages extending from each of the plurality of the cylinders;
a confluence air intake passage formed by merging the divergent air intake passages; and
an air flow meter placed in the confluence air intake passage, wherein in all of the plurality of the cylinders, if an increase of the fuel injection amount calculated by the fuel injection amount calculating portion is larger than a fuel injection amount increase threshold, if the in-cylinder pressure detected by the in-cylinder pressure sensor is larger than an in-cylinder pressure increase threshold, and if the heat generation amount calculated by the heat generation amount calculating portion is larger than a heat generation amount increase threshold, the abnormality cause discriminating portion judges that the abnormality relating to decrement of an air flow rate measured by the air flow meter occurs, and wherein in said all of the plurality of the cylinders, if a decrease of the fuel injection amount calculated by the fuel injection amount calculating portion is larger than a fuel injection amount decrease threshold, if the in-cylinder pressure detected by the in-cylinder pressure sensor is smaller than or equal to an in-cylinder pressure decrease threshold, and if the heat generation amount calculated by the heat generation amount calculating portion is smaller than or equal to a heat generation amount decrease threshold, the abnormality cause discriminating portion judges that the abnormality relating to increment of the air flow rate measured by the air flow meter occurs.

6. The abnormality detecting device of the internal combustion engine according to claim 1, further comprising:
a plurality of cylinders;
a plurality of fuel injection valves;
divergent fuel supply systems, each of the divergent fuel supply systems extending from each of the plurality of the fuel injection valves; and
a confluence fuel supply system formed by merging the divergent fuel supply systems, wherein in all of the plurality of the cylinders, if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the in-cylinder pressure detected by the in-cylinder pressure sensor is larger than an in-cylinder pressure decrease threshold, and if the heat generation amount calculated by the heat generation amount calculating portion is smaller than or equal to a heat generation amount increase threshold, the abnormality cause discriminating portion judges that the abnormality relating to decrement of a flow rate of fuel flowing through the confluence fuel supply system occurs, and wherein in said all of the plurality of the cylinders, if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the in-cylinder pressure detected by the in-cylinder pressure sensor is larger than the in-cylinder pressure decrease threshold, and if the heat generation amount calculated by the heat generation amount calculating portion is larger than a heat generation amount decrease threshold, the abnormality cause discriminating portion judges that the abnormality relating to increment of the flow rate of the fuel flowing through the confluence fuel supply system occurs.

7. The abnormality detecting device of the internal combustion engine according to claim 1, wherein the abnormality cause discriminating portion discriminates the cause of the abnormality on the basis of the fuel injection amount, the in-cylinder pressure, the heat generation amount, and a ratio of the heat generation amount to the in-cylinder pressure.

8. The abnormality detecting device of the internal combustion engine according to claim 7, wherein if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the heat generation amount calculated by the heat generation amount calculating portion increases in comparison with a change of the in-cylinder pressure, and if the ratio of the heat generation amount to the in-cylinder pressure is larger than a ratio increase threshold, the abnormality cause discriminating portion judges that there is a possibility that at least one of the abnormality relating to combustion deterioration in the cylinder, and the abnormality relating to increment of the crank angle period calculated by the crank angle period calculating portion occurs, wherein the abnormality relating to the increment of the crank angle period is caused by an induction noise, and wherein if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion decreases in comparison with the change of the in-cylinder pressure, and if the ratio of the heat generation amount to the in-cylinder pressure is smaller than or equal to a ratio decrease threshold, the abnormality cause discriminating portion judges that there is a possibility that the abnormality relating to decrement of the crank angle period calculated by the crank angle period calculating portion occurs, wherein the abnormality relating to the decrement of the crank angle period is caused by the induction noise.

9. The abnormality detecting device of the internal combustion engine according to claim 7, wherein if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the heat generation amount calculated by the heat generation amount calculating portion is smaller than or equal to a heat generation amount increase threshold, if the heat generation amount calculated by the heat generation amount calculating portion decreases in comparison with a change of the in-cylinder pressure, and if the ratio of the heat generation amount to the in-cylinder pressure is smaller than or equal to a ratio increase threshold, the abnormality cause discriminating portion judges that the abnormality relating to decrement of a flow rate of fuel injected from the fuel injection valve occurs, and wherein if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion increases in comparison with the change of the in-cylinder pressure, and if the ratio of the heat generation amount to the in-cylinder pressure is larger than a ratio decrease threshold, the abnormality cause discriminating portion judges that the abnormality relating to increment of the flow rate of the fuel injected from the fuel injection valve occurs.

10. The abnormality detecting device of the internal combustion engine according to claim 7, further comprising:
a plurality of cylinders;
a plurality of fuel injection valves;
divergent fuel supply systems, each of the divergent fuel supply systems extending from each of the plurality of the fuel injection valves; and
a confluence fuel supply system formed by merging the divergent fuel supply systems, wherein in all of the plurality of the cylinders, if an increase of the fuel injection amount calculated by the fuel injection amount calculating portion is larger than a fuel injection amount increase threshold, if the in-cylinder pressure detected by the in-cylinder pressure sensor is smaller than or equal to an in-cylinder pressure increase threshold, if the heat generation amount calculated by the heat generation amount calculating portion is smaller than or equal to a heat generation amount increase threshold, if the heat generation amount calculated by the heat generation amount calculating portion decreases in comparison with a change of the in-cylinder pressure, and if the ratio of the heat generation amount to the in-cylinder pressure is smaller than or equal to a ratio increase threshold, the abnormality cause discriminating portion judges that the abnormality relating to decrement of a flow rate of fuel flowing through the confluence fuel supply system occurs, and wherein in said all of the plurality of the cylinders, if a decrease of the fuel injection amount calculated by the fuel injection amount calculating portion is larger than a fuel injection amount decrease threshold, if the in-cylinder pressure detected by the in-cylinder pressure sensor is smaller than or equal to the in-cylinder pressure increase threshold, if the heat generation amount calculated by the heat generation amount calculating portion is smaller than or equal to the heat generation amount increase threshold, if the heat generation amount calculated by the heat generation amount calculating portion increases in comparison with the change of the in-cylinder pressure, and if the ratio of the heat generation amount to the in-cylinder pressure is larger than a ratio decrease threshold, the abnormality cause discriminating portion judges that the abnormality relating to increment of the flow rate of the fuel flowing through the confluence fuel supply system occurs.
